(19) United States
(12) Patent Application Publication
(10) Pub. No.: US 2026/0121502 A1
(43) Pub. Date: Apr. 30, 2026

(54) BIOINSPIRED MAGNETICALLY INNER ACTUATED ROBOT SYSTEM

(71) Applicant: City University of Hong Kong, Kowloon (HK)

(72) Inventors: Jun LIU, Shatin (HK); Min WANG, Fuzhou City (CN); Tianqi YANG, Wuhan (CN); Rui LIU, Kowloon (HK); Tianyi WU, Kowloon (HK)

(73) Assignee: City University of Hong Kong, Kowloon (HK)

(21) Appl. No.: 18/931,627

(22) Filed: Oct. 30, 2024

(51) Int. Cl. H02K 41/03; B62D 63/04

(52) U.S. Cl. CPC H02K 41/031; B62D 63/04

(57) ABSTRACT

A microstrip antenna which includes a substrate, a microstrip patch configured on a first side of the substrate, a ground configured on a second side of the substrate which is opposite to the first side, and a first shorting wall extending from a side of the microstrip patch toward the ground. The first shorting wall substantially overlaps with the substrate on a direction that is perpendicular to the microstrip patch. The first shorting wall is located at a first non-radiating edge of the microstrip antenna. Dummy elements are no longer needed in this design, which makes it compact.

### FIELD OF INVENTION

This invention relates to microrobots, for example those adapted to move in high-drag environments or hard-to-reach tubular environments.

### BACKGROUND OF INVENTION

Microrobots exhibit remarkable capabilities in navigating challenging environments, which are difficult or hazardous for humans to access, such as subterranean worlds, disaster scenes, and tubular environments. Recent advancements in miniature robotics have enabled a diverse array of applications, including wall-climbing [1]-[3], pipeline inspection [4], drug delivery [5], [6], and deep-sea inspection [7]. However, existing microrobots are limited in the low force and energy output at small scale (e.g., less than 10 cm in length and 10 g in mass), thereby restricting their broader utility. Creating a microrobot capable of providing sufficient force and energy is challenging due to limitations in powering capacity and transmission components at small scales, but which is essential for extending their applications to high-friction environments [8].

In various applications, the microrobot is required to navigate in high-drag environments, such as viscous oil, subterranean mediums, and rough ground when robots bear heavy payloads. A widely used locomotion mechanism in low Reynolds number environments is inspired by flagella-based microorganisms [9]-[11]. However, flagellar motion is difficult to achieve on solid ground due to insufficient impulse force. Navigating underground presents a formidable challenge due to the high resistive force in soil and granular mediums, which exceeds that in water or air by orders of magnitude [12]. Conventional solutions include the employment of drilling [13], hammering [14] and screwing [15] mechanisms. However, these approaches require bulky and heavy mechanical parts, limiting their applications in confined spaces. Recently, a pneumatic-driven expanding robot was designed to function within granular mediums [16]. However, the position and trajectory control are limited due to the intrinsic pneumatic design. In another study, researchers introduced an insect-scale robot capable of jumping to a height of 56 cm using a combustion-driven mechanism [17]. Despite the considerable energy produced, applications reliant on combustion pose safety concerns due to the utilization of chemical fuel. While the mentioned robots were designed to overcome high drag forces in specific environments, a universal design paradigm and actuation mechanism have yet to be developed for miniature microrobots to generate ample force in various terrains.

Natural organisms possess delicate physiological structures, unique actuation mechanisms, and exceptional adaptability to the environments, making them invaluable sources of inspiration for the design and creation of intelligent machines. Researchers have explored various organisms, ranging from plants and insects to mammals, to extract novel locomotion principles and design versatile structures for bioinspired robots [18]-[22].

### REFERENCES

The following references are referred to throughout this specification, as indicated by the numbered brackets. The disclosures of each of these references are hereby incorporated by reference herein in their entireties for all purposes.
[1] 1. G. Gu, J. Zou, R. Zhao, X. Zhao, and X. Zhu, “Soft wall-climbing robots,” Science Robotics, vol. 3, no. 25, p. eaat2874, 2018.
[2] W. Pang, S. Xu, J. Wu, R. Bo, T. Jin, Y. Xiao, Z. Liu, F. Zhang, X. Cheng, K. Bai et al., “A soft microrobot with highly deformable 3d actuators for climbing and transitioning complex surfaces,” Proceedings of the National Academy of Sciences, vol. 119, no. 49, p. e2215028119, 2022.
[3] S. Hong, Y. Um, J. Park, and H.-W. Park, “Agile and versatile climbing on ferromagnetic surfaces with a quadrupedal robot,” Science Robotics, vol. 7, no. 73, p. eadd1017, 2022.
[4] C. Tang, B. Du, S. Jiang, Q. Shao, X. Dong, X.-J. Liu, and H. Zhao, “A pipeline inspection robot for navigating tubular environments in the sub-centimeter scale,” Science Robotics, vol. 7, no. 66, p. eabm8597, 2022.
[5] Q. Ze, S. Wu, J. Nishikawa, J. Dai, Y. Sun, S. Leanza, C. Zemelka, L. S. Novelino, G. H. Paulino, and R. R. Zhao, “Soft robotic origami crawler,” Science advances, vol. 8, no. 13, p. eabm7834, 2022.
[6] J. Zhang, Z. Ren, W. Hu, R. H. Soon, I. C. Yasa, Z. Liu, and M. Sitti, “Voxelated threedimensional miniature magnetic soft machines via multimaterial heterogeneous assembly,” Science robotics, vol. 6, no. 53, p. eabf0112, 2021.
[7] G. Li, X. Chen, F. Zhou, Y. Liang, Y. Xiao, X. Cao, Z. Zhang, M. Zhang, B. Wu, S. Yin et al., “Self-powered soft robot in the mariana trench,” Nature, vol. 591, no. 7848, pp. 66-71, 2021.
[8] O. Erin, X. Liu, J. Ge, J. Opfermann, Y. Barnoy, L. O. Mair, J. U. Kang, W. Gensheimer, I. N. Weinberg, Y. Diaz-Mercado et al., “Overcoming the force limitations of magnetic robotic surgery: Magnetic pulse actuated collisions for tissue-penetrating-needle for tetherless interventions,” Advanced Intelligent Systems, vol. 4, no. 6, p. 2200072, 2022.
[9] L. Zhang, J. J. Abbott, L. Dong, B. E. Kratochvil, D. Bell, and B. J. Nelson, “Artificial bacterial flagella: Fabrication and magnetic control,” Applied Physics Letters, vol. 94, no. 6, 2009.
[10] Z. Ye, S. Regnier, and M. Sitti, “Rotating magnetic miniature swimming robots with mul-'tiple flexible flagella,” IEEE Transactions on Robotics, vol. 30, no. 1, pp. 3-13, 2013.
[11] D. J. Bell, S. Leutenegger, K. Hammar, L. X. Dong, and B. J. Nelson, “Flagella-like propulsion for microrobots using a nanocoil and a rotating electromagnetic field,” in Proceedings 2007 IEEE international conference on robotics and automation. IEEE, 2007, pp. 1128-1133.
[12] R. D. Maladen, Y. Ding, P. B. Umbanhowar, A. Kamor, and D. I. Goldman, “Mechanical models of sandfish locomotion reveal principles of high performance subsurface sandswimming,” Journal of The Royal Society Interface, vol. 8, no. 62, pp. 1332-1345, 2011.
[13] C. Pitcher and Y. Gao, “Analysis of drill head designs for dual-reciprocating drilling technique in planetary regoliths,” Advances in Space Research, vol. 56, no. 8, pp. 1765-1776, 2015.
[14] J. Grygorczuk, Ł. Wisniewski, B. Kedziora, M. Borys, R. Przybyla, T. Kuci' nski, M. Os-'sowski, W. Konior, O. Kromer, T. Spohn “et al., “Hammering mechanism for hp3 experiment (insight),” in Proceedings of the 43rd Aerospace Mechanisms Symposium. NASA Ames Research Center Santa Clara, 2016, pp. 415-428.
[15] K. Nagaoka, T. Kubota, M. Otsuki, and S. Tanaka, “Experimental study on autonomous burrowing screw robot for subsurface exploration on the moon,” in 2008 IEEE/RSJ International Conference on Intelligent Robots and Systems. IEEE, 2008, pp. 4104-4109.
[16] N. D. Naclerio, A. Karsai, M. Murray-Cooper, Y. Ozkan-Aydin, E. Aydin, D. I. Goldman, and E. W. Hawkes, “Controlling subterranean forces enables a fast, steerable, burrowing soft robot,” Science Robotics, vol. 6, no. 55, p. eabe2922, 2021.
[17] C. A. Aubin, R. H. Heisser, O. Peretz, J. Timko, J. Lo, E. F. Helbling, S. Sobhani, A. D. Gat, and R. F. Shepherd, “Powerful, soft combustion actuators for insect-scale robots,” Science, vol. 381, no. 6663, pp. 1212-1217, 2023.
[18] E. W. Hawkes, L. H. Blumenschein, J. D. Greer, and A. M. Okamura, “A soft robot that navigates its environment through growth,” Science Robotics, vol. 2, no. 8, p. eaan3028, 2017.
[19] R. Baumgartner, A. Kogler, J. M. Stadlbauer, C. C. Foo, R. Kaltseis, M. Baumgartner, G. Mao, C. Keplinger, S. J. A. Koh, N. Arnold et al., “A lesson from plants: high-speed soft robotic actuators,” Advanced Science, vol. 7, no. 5, p. 1903391, 2020.
[20] I. Must, E. Sinibaldi, and B. Mazzolai, “A variable-stiffness tendril-like soft robot based on reversible osmotic actuation,” Nature communications, vol. 10, no. 1, p. 344, 2019.
[21] Y. Wu, J. K. Yim, J. Liang, Z. Shao, M. Qi, J. Zhong, Z. Luo, X. Yan, M. Zhang, X. Wang et al., “Insect-scale fast moving and ultrarobust soft robot,” Science robotics, vol. 4, no. 32, p. eaax1594, 2019.
[22] Y. Tang, Y. Chi, J. Sun, T.-H. Huang, O. H. Maghsoudi, A. Spence, J. Zhao, H. Su, and J. Yin, “Leveraging elastic instabilities for amplified performance: Spine-inspired highspeed and high-force soft robots,” Science advances, vol. 6, no. 19, p. eaaz6912, 2020.
[23] M. A. Simon, W. A. Woods, Y. V. Serebrenik, S. M. Simon, L. I. van Griethuijsen, J. J. Socha, W.-K. Lee, and B. A. Trimmer, “Visceral-locomotory pistoning in crawling caterpillars,” Current biology, vol. 20, no. 16, pp. 1458-1463, 2010.
[24] E. S. Heckscher, S. R. Lockery, and C. Q. Doe, “Characterization of drosophila larval crawling at the level of organism, segment, and somatic body wall musculature,” Journal of Neuroscience, vol. 32, no. 36, pp. 12 460-12 471, 2012.
[25] G. E. Rotheray and G. E. Rotheray, “Mobility and locomotion,” Ecomorphology of Cyclorrhaphan Larvae (Diptera), pp. 87-122, 2019.
[26] D. Ross, K. Lagogiannis, and B. Webb, “A model of larval biomechanics reveals exploitable passive properties for efficient locomotion,” in Biomimetic and Biohybrid Systems: 4th International Conference, Living Machines 2015, Barcelona, Spain, Jul. 28-31, 2015, Proceedings 4. Springer, 2015, pp. 1-12.
[27] C. Pehlevan, P. Paoletti, and L. Mahadevan, “Integrative neuromechanics of crawling in d. melanogaster larvae,” Elife, vol. 5, p. e11031, 2016.
[28] L. Van Griethuijsen and B. Trimmer, “Locomotion in caterpillars,” Biological Reviews, vol. 89, no. 3, pp. 656-670, 2014.
[29] G. Sutton, “Biomechanics: An army marching with its stomach,” Current Biology, vol. 20, no. 16, pp. R668-R669, 2010.
[30] M. Cobb, “Caterpillars move like pistons,” Journal of Experimental Biology, vol. 214, no. 1, pp. iv-iv, 2011.
[31] F. Ongaro, S. Pane, S. Scheggi, and S. Misra, “Design of an electromagnetic setup for independent three-dimensional control of pairs of identical and nonidentical microrobots,” IEEE transactions on robotics, vol. 35, no. 1, pp. 174-183, 2018.
[32] A. W. Mahoney and J. J. Abbott, “Generating rotating magnetic fields with a single permanent magnet for propulsion of untethered magnetic devices in a lumen,” IEEE Transactions on Robotics, vol. 30, no. 2, pp. 411-420, 2013.
[33] A. Z. Taddese, P. R. Slawinski, M. Pirotta, E. De Momi, K. L. Obstein, and P. Valdastri, “Enhanced real-time pose estimation for closed-loop robotic manipulation of magnetically actuated capsule endoscopes,” The International journal of robotics research, vol. 37, no. 8, pp. 890-911, 2018.
[34] S. Li, H. Bai, Z. Liu, X. Zhang, C. Huang, L. W. Wiesner, M. Silberstein, and R. F. Shepherd, “Digital light processing of liquid crystal elastomers for self-sensing artificial muscles,” Science Advances, vol. 7, no. 30, p. eabg3677, 2021.
[35] A. Miriyev, K. Stack, and H. Lipson, “Soft material for soft actuators,” Nature communications, vol. 8, no. 1, p. 596, 2017.
[36] X. Wang, B. Yang, D. Tan, Q. Li, B. Song, Z.-S. Wu, A. del Campo, M. Kappl, Z. Wang, S. N. Gorb et al., “Bioinspired footed soft robot with unidirectional all-terrain mobility,” Materials Today, vol. 35, pp. 42-49, 2020.
[37] R. M. Bena, X.-T. Nguyen, A. A. Calderon, A. Rigo, and N. O. P'erez-Arancibia, “Smarti: ‘a 60-mg steerable robot driven by high-frequency shape-memory alloy actuation,” IEEE Robotics and Automation Letters, vol. 6, no. 4, pp. 8173-8180, 2021.

### SUMMARY OF INVENTION

Accordingly, the present invention, in one aspect, provides a microrobot which includes a frame having a central channel, a permanent magnet received in and adapted to move relative to the central channel, a first electromagnetic coil configured near a first end of the central channel, and a second electromagnetic coil configured near a second end of the central channel. The permanent magnet is adapted to locomote within the channel upon energization of the first electromagnetic coil and/or the second electromagnetic coil, which provides an interaction force and an impact force between the permanent magnet and the frame that are adapted to drive the microrobot to move on a surface.

In some embodiments, the central channel has a cylindrical shape. The first and second electromagnetic coils wound are respectively around first and second ends of the frame.

In some embodiments, the microrobot further includes a coil holder for the first electromagnetic coil or the second electromagnetic coil which is evenly distributed on the coil holder. The coil holder is configured at an exterior surface of the frame at a respective end of the frame.

In some embodiments, the coil holder includes grooves formed on an exterior circumferential surface of the frame.

In some embodiments, the coil holder has a length of 5 mm.

In some embodiments, the first and second electromagnetic coils have different winding directions.

In some embodiments, the first and second electromagnetic coils are electrically connected in series.

In some embodiments, the microrobot further includes an end cover at each end of the central channel. The end covers are adapted to be impacted by the permanent magnet to provide the impact force.

In some embodiments, the first electromagnetic coil is adapted to generate an attractive force to the permanent magnet while the second electromagnetic coil is adapted to generate a repelling force, and vice versa.

According to another aspect of the invention, there is provided a method of driving a microrobot to move on a surface, which contains the steps of: applying a first magnetic force, along a first direction, to a permanent magnet received in a central channel of a frame such that the permanent magnet moves toward and impacts a first end of the frame; the frame moving as a result of the impact; ceasing the first magnetic force; applying a second magnetic force, along a second direction opposite to the first direction, to the permanent magnet such that the permanent magnet moves away from the first end of the frame and impacts a second end of the frame that is opposite to the first end; and ceasing the second magnetic force.

In some embodiments, each of the first and second magnetic forces is provided by a first electromagnetic coil configured near a first end of the central channel, and/or a second electromagnetic coil configured near a second end of the central channel.

In some embodiments, Steps a) to d) are repeated so that the microrobot continues to move on the surface.

In some embodiments, the first and second electromagnetic coils have different winding directions.

In some embodiments, the first and second electromagnetic coils are electrically connected in series.

In some embodiments, Steps a) and c) are executed by applying respectively a first current to the first and second electromagnetic coils, and a second current in an opposite direction than the first current to the first and second electromagnetic coils.

In some embodiments, the second current is smaller than the first current in magnitude.

In some embodiments, Steps a)-d) are executed by applying a square wave current to the first and second electromagnetic coils.

In some embodiments, the second magnetic force is below a static friction force of the microrobot on the surface.

According to another aspect of the invention, there is provided a magnetically inner actuated miniature robot system which contains a self-actuated magnetic robot that integrates a permanent magnet and electromagnetic coils, and a signal wave generation system. The magnetic robot can be operated with a theoretically boundless workspace because no additional external magnetic sources are required to drive the robot. The signal wave can be controlled by a host computer, the controlled parameters include the current amplitude in positive direction and negative direction, the frequency and the duty cycle.

In some embodiments, the self-actuated magnetic robot includes a plastic frame with center channel to accommodate a permanent magnet, where the two ends of the frame are fabricated with grooves to assemble electromagnetic coils; a permanent magnet placed within the center channel functions like a piston to propel the robot; two plastic end covers inserted at two ends of the robot frame to limit the stroke of the permanent magnet; and a coil array formed by two set of electromagnetic coils, where the two coils are winding in different directions and arranged at two ends of the robot frame.

In some embodiments, the signal wave generation system includes a host computer used to customize the input waveform; a signal generator to output the waveform, the host computer and the signal generator are connected through the UART serial portal; and an amplifier to amplify the waveform generated by the signal generator, where the signal after amplifying is connected to the robot.

In some embodiments, the plastic robot frame is made from polyetheretherketone; a high-performance plastic material with high temperature resistance and self-lubricating properties.

In some embodiments, the plastic robot frame cylindrical and the center channel is a round through hole.

In some embodiments, the permanent magnet is made from NdFeB.

In some embodiments, the permanent magnet is cylindrical.

In some embodiments, the magnetization direction of the permanent magnet is parallel to the center channel; moreover, and the diameter of the permanent magnet is slightly small than the diameter of the center channel.

In some embodiments, the two plastic end covers are made from polylactic acid made through 3-D printing.

In some embodiments, the coil array is made from cupper wire with insulating paint to avoid contact with each other.

In some embodiments, the two plastic end covers are mounted at two ends of the center channel.

In some embodiments, the robot is a milli-scale robot or a micro robot.

In some embodiments, the robot can locomotion under the effect of the interaction force between the robot frame and the inner permanent magnet. Moreover, an impulsive trust accrues when the permanent magnet impacts the robot frame.

In some embodiments, the robot can locomote at a high velocity when there are no external loads due to interaction force between the robot frame and the permanent magnet. One can increase the velocity by increasing the input frequency.

In some embodiments, the robot has a strong load capability because of the impulsive impact force when the inner permanent magnet hits the robot frame. The load carrying capability can be increased by increasing the amplitude of input current.

One can see that exemplary embodiments of the invention therefore provide a magnetic robot which can be self-propelled without relying on external magnetic sources because of the integration of both permanent magnet and electromagnetic coils. The inner magnet can locomote within the center channel and impact the end of the plastic frame when the coils are energized. The displacement of the magnetic robot appears because of the interaction force and final impact force between the magnet and the robot frame.

The foregoing summary is neither intended to define the invention of the application, which is measured by the claims, nor is it intended to be limiting as to the scope of the invention in any way.

### BRIEF DESCRIPTION OF FIGURES

The foregoing and further features of the present invention will be apparent from the following description of embodiments which are provided by way of example only in connection with the accompanying figures, of which:

FIG. 1a is a cross-sectional view of a microrobot according to a first embodiment of the invention.

FIG. 1b shows a comparison of a conventional external magnetic actuation system and the microrobot of FIG. 1a.

FIG. 1c shows separately some components of the microrobot of FIG. 1a.

FIG. 1d illustrates the assembly process of the microrobot of FIG. 1a. Scale bar: 10 mm.

FIG. 2a shows conceptual schematics illustrating the bio-inspired design of a magnet robot according to an embodiment of the invention.

FIG. 2b shows similar locomotion style between a larvae locomotion and the microrobot of FIG. 1a.

FIG. 3a is a diagram showing comparison of the microrobot of FIGS. 1a-1d with the state-of-the-art small robots using different actuation mechanisms, in terms of load-carrying capability.

FIG. 3b is a diagram showing comparison of the microrobot of FIGS. 1a-1d with the natural creatures, in terms of load-carrying capability.

FIG. 4a is a table comparing the load capability of the of the microrobot of FIGS. 1a-1d with the state-of-the-art small robots in FIG. 3a.

FIG. 4b is a table comparing the load capability of the of the microrobot of FIGS. 1a-1d with the natural creatures of FIG. 3b.

FIG. 5a shows the drag and repulsion forces from the two electromagnetic coils on the magnet in the microrobot.

FIG. 5b shows distribution of the magnetic field along the center line of the central channel of the microrobot.

FIG. 6 illustrates modeling of the magnetic field density of cylindrical electromagnetic coil array.

FIG. 7a illustrates an interaction force between the multilayered electromagnetic coil array and the permanent magnet.

FIG. 7b illustrates calibration process of the permanent magnet.

FIG. 8a illustrates that during the positive-current phase, the propelling process involves four steps: acceleration of the magnet, impact on the end cover of the robot frame, sliding of the robot, and the subsequent resting state. Under negative current, the permanent magnet returns to its initial position, avoiding a backward movement with a lower amplitude I) than I″.

FIG. 8b shows snapshots that illustrate the magnet and MiaBot positions over a cycle of actuation (load 250 g).

FIG. 8c shows the oscillating movement of the permanent magnet (curve with symbol) drives the robot forward in each cycle of actuation.

FIG. 8d shows numerical simulation which reveals the effect of channel length (Lc) and coil holder length (Lh) on the velocity of the permanent magnet before impacting.

FIG. 8e shows that traveling time of the inner magnet decreases with an increase in driving current and the optimal results are achieved when the coil holder length (Lh) is 5 mm.

FIG. 8f shows that the numerical simulation results are validated with the experimental measurements of the average and final impacting velocity of the permanent magnet.

FIG. 9 shows the traveling time of the permanent magnet within the center channel with the coil holder length from 3 mm to 8 mm.

FIG. 10 is a schematic diagram of force measuring set up for the microrobot.

FIG. 11a shows the relationship between impact force and applied current under different coil holder length designs (3 mm, 5 mm, and 8 mm) of the microrobot.

FIG. 11b illustrates repeatability test of impact force under different actuation currents.

FIG. 11c illustrates the relationship between locomotion velocity and excitation frequency under different input currents when loading 500 g of goods.

FIG. 11d illustrates the relationship between locomotion velocity and loading weight.

FIG. 11e illustrates locomotion velocity on different types of sandpaper surfaces. Insets: 5× magnified photos of sandpaper with varying degrees of coarseness (200 grit, 400 grit, 800 grit, 1000 grit).

FIG. 11f illustrates the locomotion velocity on different surfaces, including fibers, plastics, and metals.

FIG. 12 illustrates the relationship between temperature increases and the operation time under different input currents (0.2 A, 0.3 A, 0.4 A, and 0.5 A).

FIG. 13a illustrates four stages of the microrobot's velocity and the input frequency and their relationship. Left insert: the input current wave.

FIG. 13b shows the behaviors of the microrobot at four locomotion stages.

FIG. 14a shows displacement of the microrobot moving forward for 60 s and moving backward for 60 s.

FIG. 14b shows a conventional one-actuator switched off-based single actuation method.

FIG. 14c shows a dual actuator synergies actuation approach.

FIG. 14d shows a comparison of turning (180°) trajectory of robot's center under two turning strategies.

FIG. 14e shows the time cost for turning 90° by two actuation strategies with different current inputs (Bias: 0.2 A, 0.3 A, 0.4 A, 0.5 A, cargo: 500 g).

FIG. 14f shows the trajectory of the microrobot following input signal waves of two actuators for Z trajectory, upper row: left actuator, lower row: right actuator.

FIG. 14g shows snapshots of Z trajectory following.

FIG. 15 shows a schematic diagram of the control and measuring system for the MiaBot.

### DETAILED DESCRIPTION

Spatial descriptions, such as “on,” “above,” “below,” “up,” “left,” “right,” “down,” “top,” “bottom,” “vertical,” “horizontal,” “side,” “higher,” “lower,” “upper,” “over,” “under,” and so forth, are specified with respect to a certain component or group of components, or a certain plane of a component or group of components, for the orientation of the component(s) as shown in the associated figure. It should be understood that the spatial descriptions used herein are for purposes of illustration only, and that practical implementations of the structures described herein can be spatially arranged in any orientation or manner, provided that the merits of embodiments of this disclosure are not deviated from by such arrangement.

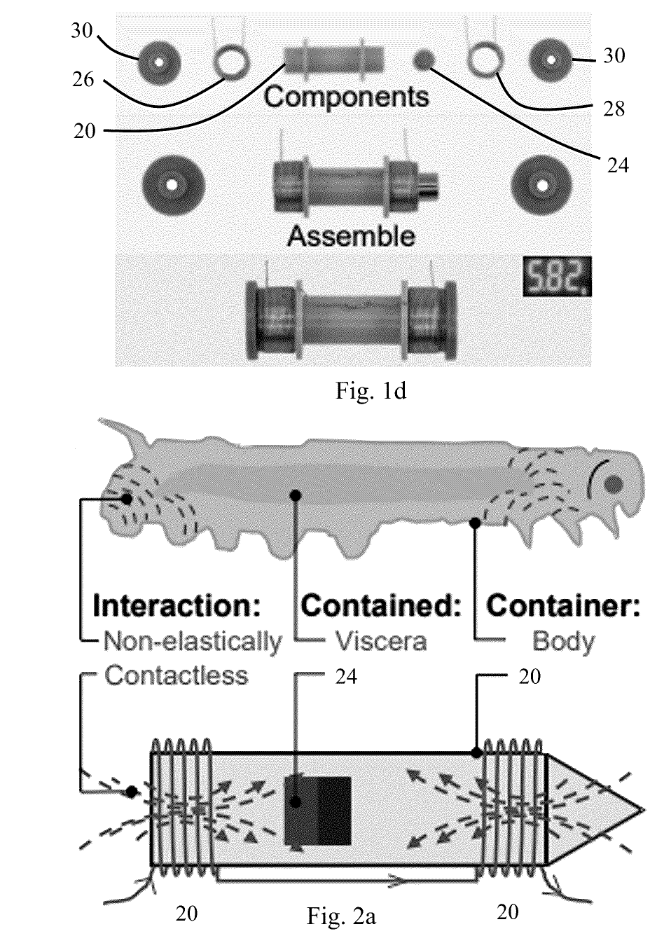

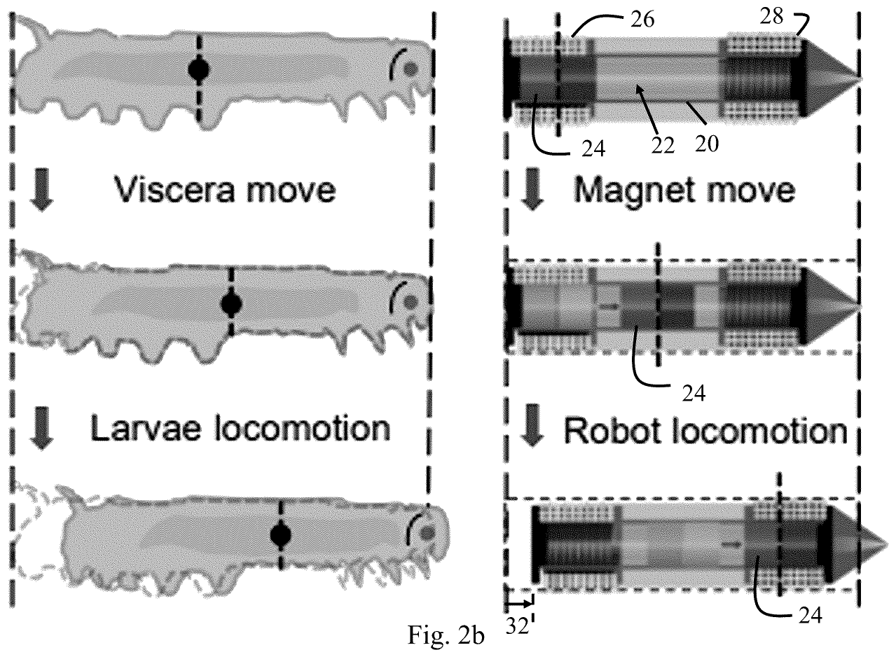

Embodiments of the invention provide microrobots inspired by the captivating locomotion behavior of crawling hawkmoth caterpillars. In a previous study, researchers uncovered a unique physiological structure in crawling Manduca sexta larvae: a distinct two-body system comprising viscera as the contained and the body wall as the container, alongside a piston-like viscera locomotion mechanism (see FIG. 2a) [23]. Subsequently, the asynchronous movement of the centroid and the body wall was also observed in other caterpillars, such as Drosophila melanogaster drosophilidae larvae and Callicera rufa tree hole larva (24-28).

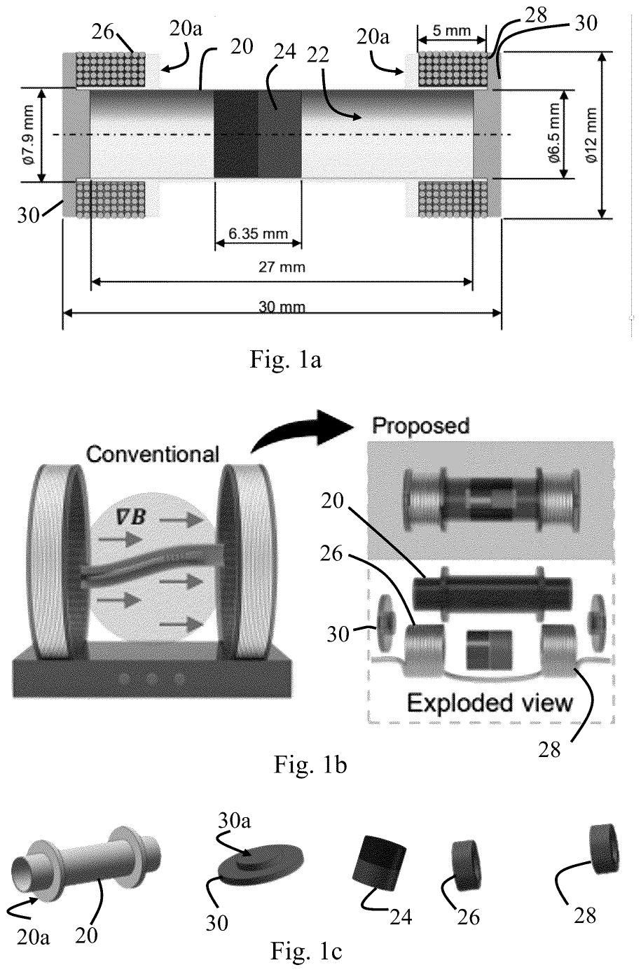

Referring to FIG. 1a-1d, inspired by the larva's structure, an internally actuated magnetic microrobot (also referred to as “MiaBot” hereinafter) is provided according to a first embodiment of the invention. The microrobot contains a frame 20 that is preferably made of plastic, and which has a central channel 22 serving as a container for a sliding permanent magnet 24 that functions as the viscera. The frame 20 has a substantially cylindrical shape and is hollow. The permanent magnet 24 is received in and adapted to move relative to the central channel 22 which is also cylindrical. As will be described in more details below, the permanent magnet 24 is adapted to locomote within the central channel 22 upon energization of a first electromagnetic coil 26 and/or a second electromagnetic coil 28, and the permanent magnet 24 provides an interaction force and an impact force between the permanent magnet 24 and the frame 20 that are adapted to drive the microrobot to move on a surface.

Adjacent to the two ends of the frame 20 there are formed two circular ribs 20a that extend radially outward, which delimit portions of the two ends such that each portion is adapted to receive one of the first and second electromagnetic coil 26, 28 thereon. In particular, on a first end of the frame 20 (which is the left end in FIGS. 1a and 1d), a first electromagnetic coil 26 is wound around the frame 20. On a second end of the frame 20 (which is the right end in FIGS. 1a and 1d), a second electromagnetic coil 28 is wound around the frame 20. To facilitate coil winding, on the two ends of the frame 20 there are grooves (not shown) formed on the external circumferential surface of the frame 20, so that the first and second electromagnetic coils 26, 28 can fit with the groove and be secured on the frame 20.

In addition, at the outermost ends of the frame 20 two end covers 30 are respectively installed and firmly mounted. The end covers 30 are preferably made of plastics like the frame 20. During operations of the microrobot, the end covers 30 are adapted to limit, and impacted by the permanent magnet 24 to provide an impact force to the frame 20. One can see from FIGS. 1a, 1b and 1d that the circular ribs 20a has similar diameters as the end covers 30. As shown in FIG. 1c, each end cover 30 has a cap shape with a protruded part 30a which is inserted into and forms an interference fit with the inner wall (not shown) of the end of the frame 20. On each end of the frame 20, the end cover 30, the circular rib 20a, and the grooves therebetween, form a coil holder for a respective one of the first and second electromagnetic coils 26, 28.

While the first and second electromagnetic coils 26, 28 are shown as discrete components in FIGS. 1a and 1d, they are preferably electrically connected to each other in series, as shown in the right sub-figure of FIG. 1b. The first and second electromagnetic coils 26, 28 have different winding directions compared to each other, for example in FIG. 1b the first electromagnetic coil 26 is wound in a counterclockwise direction (when looking at it from the left-to-right direction in FIG. 1b), while the second electromagnetic coils 28 is wound in a clockwise direction. As the first and second electromagnetic coils 26, 28 are wound respectively at the first and second ends of the frame 20, they are also configured near respectively a first end and a second end of the central channel 22.

In an exemplary implementation, the coil holder has a length of about 5 mm as shown in FIG. 1a. Dimensions of other components of the microrobot in the exemplary implementation are also shown in 1a. In particular, in the exemplary implementation, the permanent magnet is made of NdFeB, Grade N52 (K&J Magnetics, Inc., USA), and has an overall dimension of 6.35 mm in diameter and 6.35 mm in thickness. The surface field of the magnet is 6619 Gauss. The skeleton used for housing the permanent magnet and mounting the electromagnetic coil is Polyetheretherketone (PEEK), which is machined with a center channel of 6.5 mm for passing through the magnet. The PEEK has the properties of a smooth surface and high-temperature resistance (2600 for long-time operating). Two end covers are printed by a commercial FDM printer (Method, MakerBot Inc., USA). The filament is made of Polylactic acid (precision material, Method series). And the printed layer thickness layer is 0.06 mm. The end cover is firmly attached to the frame using super glue (Loctite® 406). The wire for forming the electromagnetic coil is an enamel-insulated wire with a diameter of 0.15 mm. The copper wire has the properties of good conductivity and flexibility (Baoling Jin Shu, China).

Having described the components and structure of the microrobot in FIGS. 1a-1d. The working principle of the microrobot will now be described. Similar to the non-elastic connection between the body wall and the viscera in a larvae, the interaction between the frame 20 and the permanent magnet 24 is also wirelessly connected through the magnetic field (see FIG. 2a). In each locomotion cycle of the Manduca sexta larva, the viscera slides like a piston within a container, and the motion of the viscera advances the locomotion of the larvae's body (see the left sub-figure of FIG. 2b). Similarly, in MiaBot's propelling process, the permanent magnet 24 slides in the central channel 22 of the frame 20 like a visceral piston. Afterward, as a result of the permanent magnet 24 impacting the right end cover 30 for example, the robot body slides forward as shown by the displacement 32 to the right-direction in FIG. 2b.

Although the exact advantages of the ‘visceral body pistoning’ mechanism in Manduca sexta remain unclear [23], [29], [30], the MiaBot which is inspired by this locomotion mechanism offers significant merits. (1) In contrast to magnetic actuation systems dependent on external sources [31], [32], the MiaBot integrates both the permanent magnet and electromagnetic coils, providing the robot with a theoretically boundless workspace (see FIG. 1b). (2) The straightforward energy conversion mechanism allows the MiaBot to be a smaller and lighter microrobot (with an overall dimension of <|12 mm×30 mm, and an assembled weight of 5.82 g in one example) compared to the conventional electromechanical systems relying on complex transmission components such as gears and bears. (3) the MiaBot exhibits a more robust thrust force than external magnetic source-based methodologies because magnetic forces decrease as 1/L⁴ (L is the characteristic distance between the object and the magnetic source) [33]. (4) In an exemplary facile fabrication process of the MiaBot (as shown in FIG. 1d), firstly the two electromagnetic coils 26, 28 with different winding directions are welded together. A cylindrical magnet which is the permanent magnet 24 is then placed freely within the central channel 22, which is followed by mounting the two end covers 30 on the frame 20.

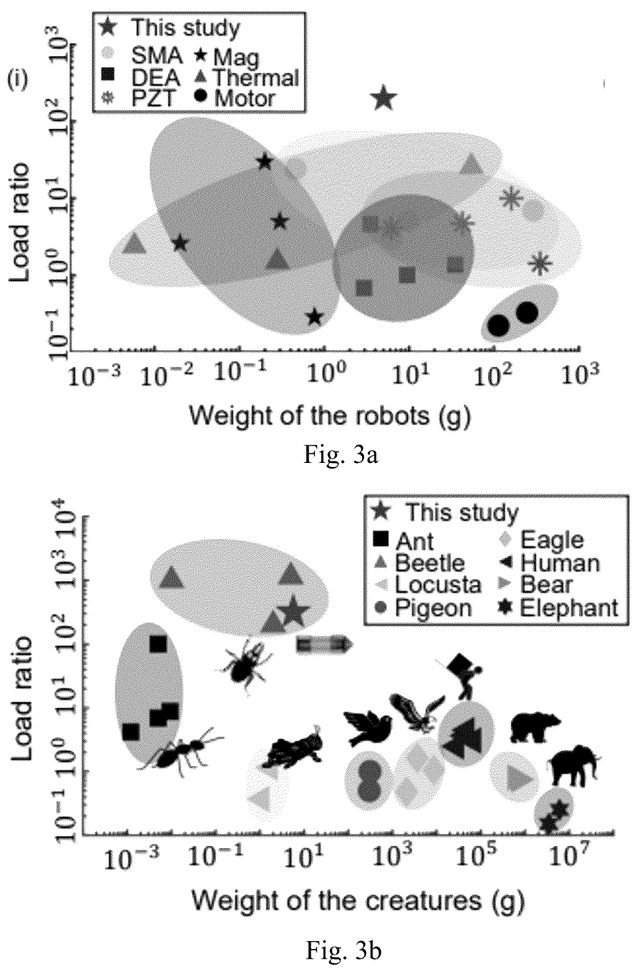

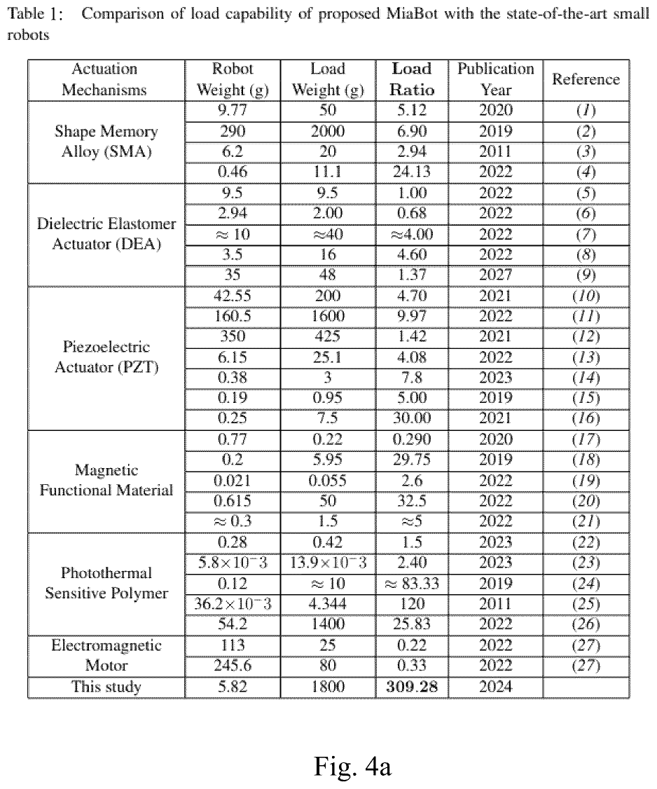

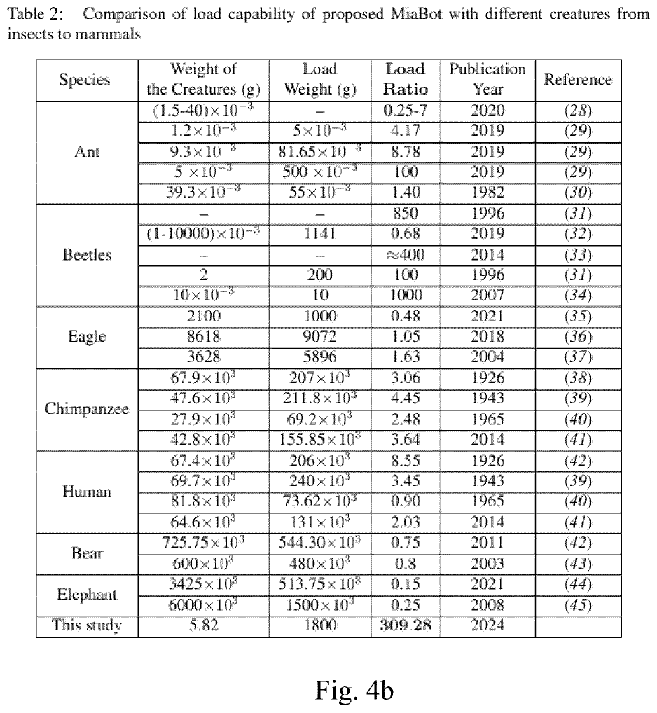

The powerful impact generated by the high-speed inner permanent magnet 24 enables the MiaBot to complete challenging tasks in both industrial and medical scenarios by overcoming high resistive forces, such as maneuvering through the granular mediums, operating in highly viscous silicon oil, and carrying cargo exceeding 300 times its body weight in one example. FIG. 3a compares the loading capability of the Miabot (which is indicated as “This study” in FIG. 3a with the state-of-the-art microrobots by different actuation mechanisms and natural creatures. Detailed data and citations are shown in Table 1 of FIG. 4a and Table 2 of FIG. 4b respectively (in which the Miabot is also indicated as “This study”). The results show that the Miabot exhibits superior loading performance compared to other miniature robots and surpasses most natural creatures, falling short only of beetles. With the compact structure, MiaBot also presents significant potential for medical scenarios, particularly in constrained spaces such as the gastrointestinal tract. For example, the microrobot can function as a biopsy or drug delivery device when attaching a sharp needle to the permanent magnet or preloading drugs to the sub-containers inside the center channel. The MiaBot establishes a new paradigm in designing next-generation microrobots with substantial force output suitable for applications in high-resistive environments and confined spaces.

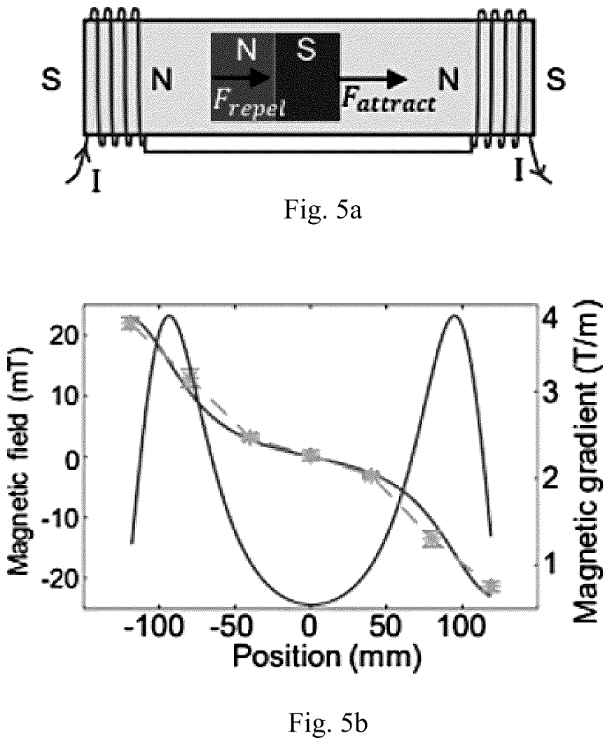

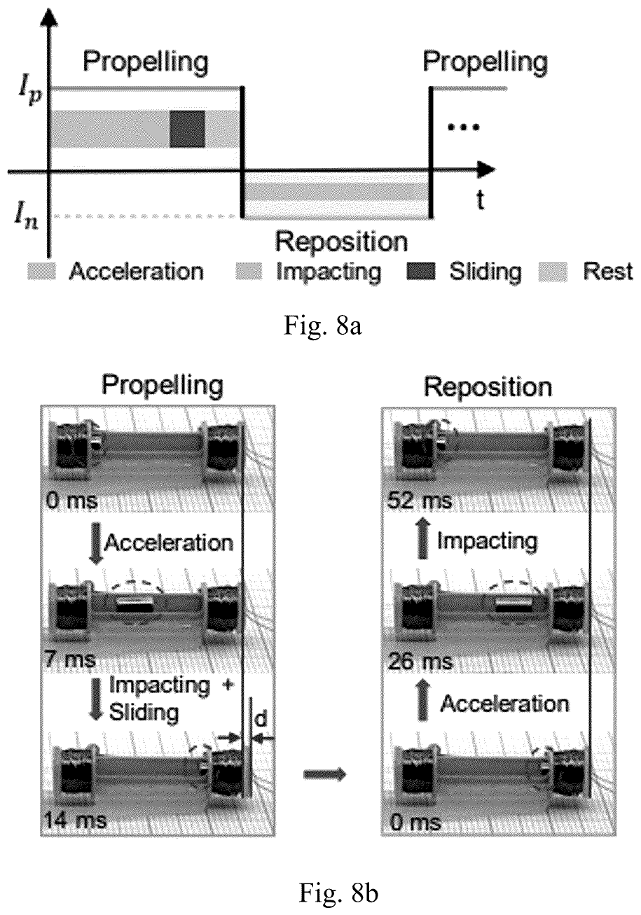

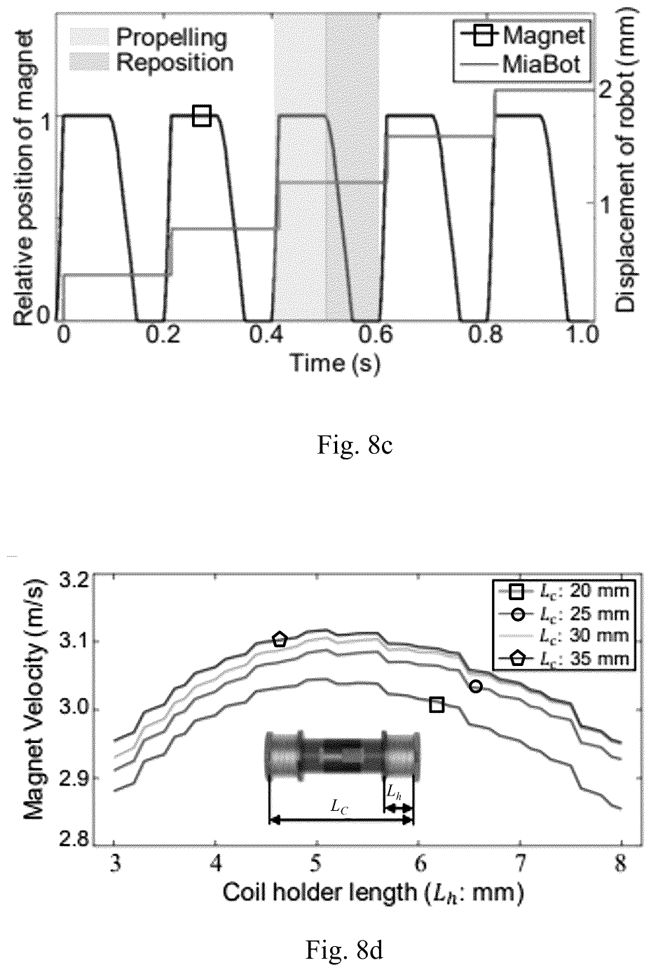

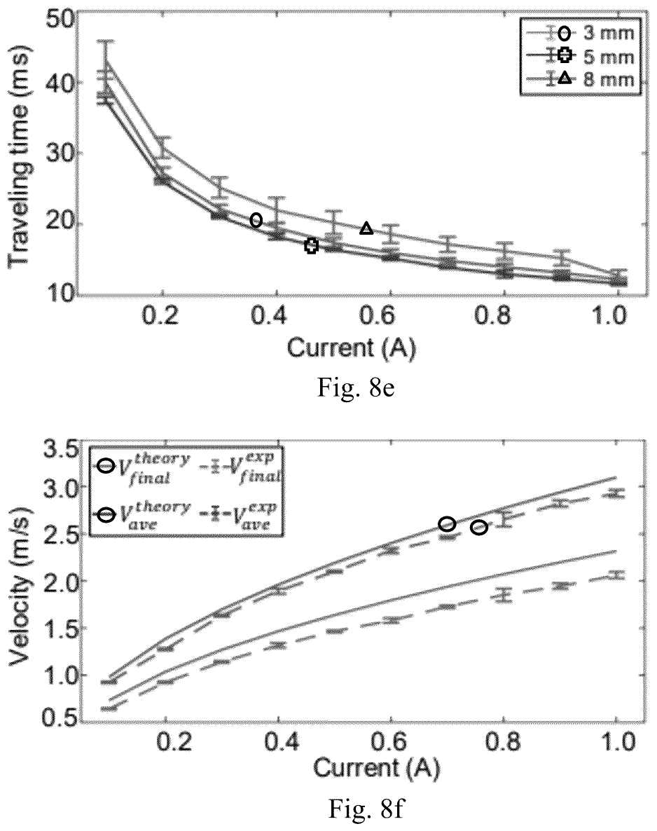

In the following sections, the actuation mechanism and structure optimization process of the MiaBot will be described in detail. By applying a positive current (Ip, see FIG. 8a) to the electromagnetic coils, a magnetic field with decreasing intensity is generated by the left coil along the center channel, while the right coil generates an increasing magnetic field in the opposite direction. As a result, a continuous magnetic field gradient with the same direction is established along the center channel of the container (see FIG. 5b), and the magnet will be repelled by the left coil and attracted by the right coil (see FIG. 5a). In particular, when a constant current is applied to the coils, the permanent magnet within the center channel can slide to one side of the frame under the effect of the magnetic interaction force between the permanent magnet and the coils. Because the winded direction of the two coils is different, the generated magnetic fields are in opposite directions along the center channel. In this way, the permanent magnet will be propelled by different forces from the coils, namely repulsion, and attraction, resulting in a continuous acceleration of the magnet (see FIG. 5a). The distribution of the magnetic field along the center line of the channel. One can see from FIG. 5b that the magnetic field is continuously decreased along the center line, where the simulated results are represented by the solid line and the measured results are shown in a dashed line. The continuously decreased magnetic field creates the gradient filed in a constant direction, indicating the permanent magnet within the center channel can always move towards a fixed direction. For continuous actuation, one can simply reverse the direction of the input current to reposition the magnet to the initial position.

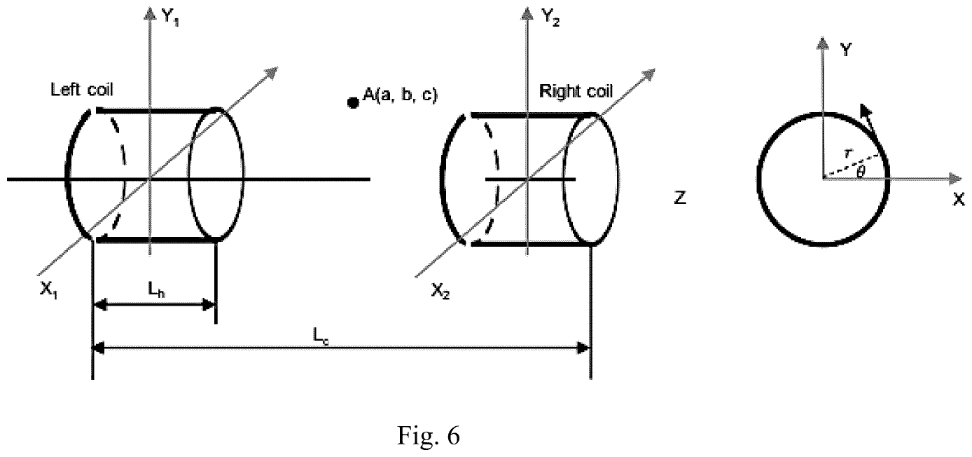

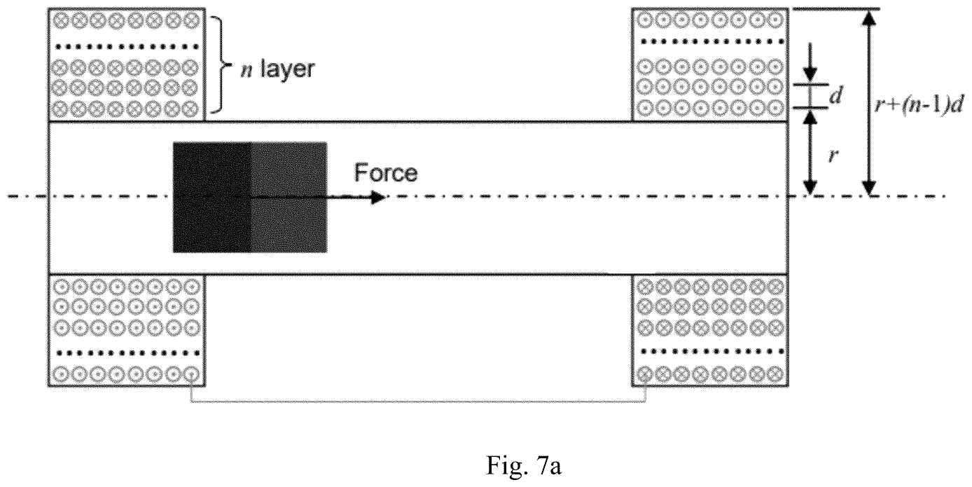

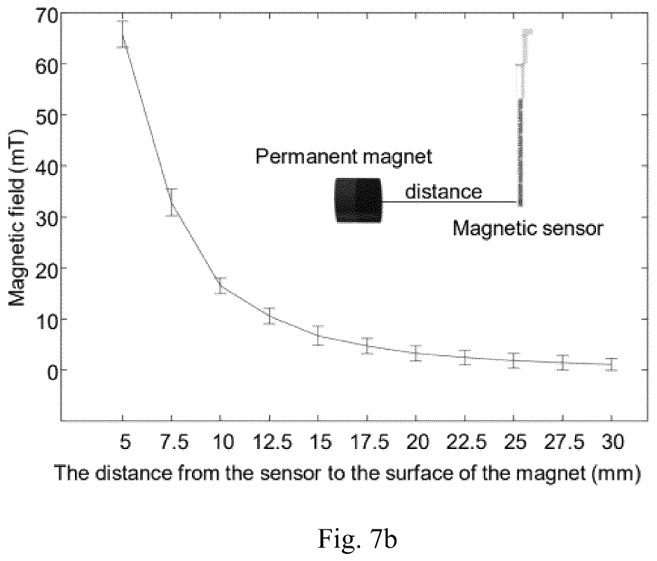

Under the effect of the magnetic field gradient, the inner magnet keeps accelerating and impacts the end cover at high speed, resulting in a forward motion of the microrobot. The theoretical magnetic force at different positions is given by

$${F}_{p} = ∇ ( M \cdot {B}_{p} ) \qquad ( 1 )$$

where M represents the magnetic moment of the sliding magnet and Bp is the overall magnetic field generated by two coils. The overall magnetic field along the center line can be expressed as

$${B}_{z} = \frac{{μ}_{0} {n}_{l} {n}_{t}}{2} I {\int }_{0}^{{L}_{h}} {\int }_{{R}_{1}}^{{R}_{2}} ( \frac{{R}^{2}}{{( {( z - l )}^{2} + {R}^{2} )}^{1.5}} - \frac{{R}^{2}}{{( {( {L}_{c} - {L}_{h} + l - z )}^{2} + {R}^{2} )}^{1.5}} ) dRdl \qquad ( 2 )$$

where μ₀ is the vacuum permeability, nₗ is the coil's turns of each layer, nₜ is the layer number of the coil, I is the input current, R1 and R2 are the inner and outer radius of the coil, z is the distance from the calculated point to the end of the coil, Lc is wide of a coil array, Lh is the length of center channel, R is the radius of the integral coil and 1 represents the distance from the end of coil to the center of the integral coil loop. A detailed distribution of the magnetic field generated by the coils is shown in FIG. 6 and the interaction force between the coils and the magnet is provided in FIG. 7a. In FIG. 6, the Z-axis is along with the length of the coordinate and at the center of the coil. The X-axis and Y-axis are perpendicular and intersect at the center of the circle along the radial direction of the circle. The coils are evenly distributed on the coil holder with a length of Lₕ, the distance between the external midpoint of two coil holders is L_{c}, A(a, b, c) is a random point between two coils, r is the radius of the coil holder, dl is an integral length of the coil, a is a random point on the coil, φ is the angle between x-axis and line from point a to the coordinate origin point o. The two sub-figures in FIG. 6 on the left are front views, while the remaining one on the right is a side view. In FIG. 7a, the electromagnetic coil is composed of n layers of copper with a diameter of d, and the wiring radius of the inner layer is r. The permanent magnet will oscillate between two electromagnets under the magnetic interaction force.

As shown in FIG. 6, the actuation electromagnetic coil is composed of two coils with a coincident central axis. The two coils are in the same geometry, with the length and radius of the cylindrical coil being Lₕ and r, respectively. The two coils are wired in different directions, and the direction of the current is shown in the figures using blue arrows. The external center points of two coils are regarded as the origin point of building the coordinate systems. Based on the Biot-Savart Law, the magnetic field dBₑ at the position of A (a, b, c) generated by a unit loop current can be estimated. The result is shown in the following:

$$d {B}_{c} = \frac{{μ}_{0}}{4 π} {\int }_{L} \frac{I d l \times P}{{‖ P ‖}^{3}} \qquad ( 3 )$$

where L is the integral path, I is the input current, dl is the length of the coil element, P=(a−x, b−y, c−z) is the vector from point A to point P. Overall, the magnetic field generated by a whole electromagnetic coil unit should be:

$${B}_{c} = {\int }_{0}^{{L}_{h}} d {B}_{c} \qquad ( 4 )$$

The length of dl is rdθ, and the direction of dl is (−sin θ, cos θ, 0), so dl can be expressed as

$$d l = ( - s in θ , cos θ , 0 ) rd θ \qquad ( 5 )$$

By superimposing the magnetic field generated by the coils along an electromagnetic unit. The magnetic field density can be estimated using the following question:

$${B}_{c} = \frac{{μ}_{0} r}{4 π} {\int }_{0}^{{L}_{h}} {\int }_{0}^{2 π} \frac{( \begin{matrix}i & j & k \\ − sin θ & cos θ & 0 \\ a − x & b − y & c − z\end{matrix} )}{{( {( a - x )}^{2} + {( b - y )}^{2} + {( c - z )}^{2} )}^{\frac{3}{2}}} d θ dz \qquad ( 6 )$$

$$where$$

$$x = r cos θ \qquad ( 7 )$$

$$y = r sin θ \qquad ( 8 )$$

The magnetic field density along three axes can be obtained by decomposing the above equation into three compositions:

$${B}_{cx} = \frac{{μ}_{0} r}{4 π} {\int }_{0}^{{L}_{h}} {\int }_{0}^{2 π} \frac{( c - z ) cos θ}{{( {( a - x )}^{2} + {( b - y )}^{2} + {( c - z )}^{2} )}^{\frac{3}{2}}} d θ dz \qquad ( 9 )$$

$${B}_{c y} = \frac{{μ}_{0} r}{4 π} {\int }_{0}^{{L}_{h}} {\int }_{0}^{2 π} \frac{( c - z ) sin θ}{{( {( a - x )}^{2} + {( b - y )}^{2} + {( c - z )}^{2} )}^{\frac{3}{2}}} d θ dz \qquad ( 10 )$$

$${B}_{c y} = \frac{{μ}_{0} r}{4 π} {\int }_{0}^{{L}_{h}} {\int }_{0}^{2 π} \frac{r - b sin θ - acos θ}{{( {( a - x )}^{2} + {( b - y )}^{2} + {( c - z )}^{2} )}^{\frac{3}{2}}} d θ dz \qquad ( 11 )$$

To simplify the calculation process, the above integral functions (eq. 4-6) can be approximated using numerical integral methods. Here, the Simpson rule is applied for the calculation of the integration of integral variables, and the closed-form analytic expressions are as follows:

$${B}_{cx} = \frac{{μ}_{0} r {L}_{h}}{24 π} ( {F}_{x θ} ( 0 ) + 4 {F}_{x θ} ( \frac{{L}_{h}}{2} ) + {F}_{x θ} ( {L}_{h} ) ) \qquad ( 12 )$$

$${B}_{cy} = \frac{{μ}_{0} r {L}_{h}}{24 π} ( {F}_{y θ} ( 0 ) + 4 {F}_{y θ} ( \frac{{L}_{h}}{2} ) + {F}_{y θ} ( {L}_{h} ) ) \qquad ( 13 )$$

$${B}_{c z} = \frac{{μ}_{0} r {L}_{h}}{24 π} ( {F}_{z θ} ( 0 ) + 4 {F}_{z θ} ( \frac{{L}_{h}}{2} ) + {F}_{z θ} ( {L}_{h} ) ) \qquad ( 14 )$$

$$where$$

$${f}_{x} ( 0 , z ) = \frac{( c - z ) cos θ}{{( {( a - x )}^{2} + {( b - y )}^{2} + {( c - z )}^{2} )}^{\frac{2}{3}}} \qquad ( 15 )$$

$${f}_{y} ( 0 , z ) = \frac{( c - z ) sin θ}{{( {( a - x )}^{2} + {( b - y )}^{2} + {( c - z )}^{2} )}^{\frac{2}{3}}} \qquad ( 16 )$$

$${f}_{z} ( 0 , z ) = \frac{r - b sin θ - acos θ}{{( {( a - x )}^{2} + {( b - y )}^{2} + {( c - z )}^{2} )}^{\frac{2}{3}}} \qquad ( 17 )$$

Note that the calculated magnetic density in three axes (BCx, BCx, BCx in eqs. 12-14) is based on a layer of wire on the coil holder surface. Meanwhile, the electromagnetic coil used in the MiaBot is a multi-layered coil, as the electromagnetic coil has n layers with a diameter of d, and the winding radius of the innermost layer and the outermost layer is r and r+(n−1)×d, respectively. As a result, the magnetic density generated by an electromagnetic unit should be

$${B}_{n c x} = {\int }_{r}^{r + ( n - 1 ) d} {B}_{c x} ( r ) d r = {\sum }_{i = 1}^{n} {B}_{cx} ( {r}_{i} ) \qquad ( 18 )$$

$${B}_{ncy} = {\int }_{r}^{r + ( n - 1 ) d} {B}_{c y} ( r ) d r = {\sum }_{i = 1}^{n} {B}_{c y} ( {r}_{i} ) \qquad ( 19 )$$

$${B}_{n c z} = {\int }_{r}^{r + ( n - 1 ) d} {B}_{c z} ( r ) d r = {\sum }_{i = 1}^{n} {B}_{c z} ( {r}_{i} ) \qquad ( 20 )$$

The actuation coil is composed of two electromagnetic units. The aforementioned B_{ncx}, B_{ncy} and B_{ncz} is generated by an electromagnetic unit, for the total magnetic density should be the superposition of the magnetic field generated by two electromagnetic units, which can be expressed as follows:

$${B}_{x} = {B}_{n c x}^{left} + {B}_{n c x}^{right} \qquad ( 21 )$$

$${B}_{y} = {B}_{ncy}^{left} + {B}_{ncy}^{right} \qquad ( 22 )$$

$${B}_{z} = {B}_{n c z}^{left} + {B}_{n c z}^{right} \qquad ( 23 )$$

The permanent magnet used in this paper is a neodymium magnet with a magnetic moment of m. To simplify the calculation process, the permanent magnet is regarded as a dipole. The interaction force between the electromagnetic units and the permanent magnet is

$$F = ( {m}_{x} \frac{\partial }{{\partial }_{x}} + {m}_{y} \frac{\partial }{{\partial }_{y}} + {m}_{z} \frac{\partial }{{\partial }_{z}} ) B \qquad ( 24 )$$

where m=(mx, my, mz)^{T}, ∇ is a gradient operator and B=(Bx, By, Bz)^{T}. Because the diameter of the permanent magnet is similar to the diameter of the center, the moving trajectory of the permanent magnet is always along the center line of the tube. To this end, the magnetic force along the x and y directions should be canceled due to the symmetry magnetic field of a circular coil. And the magnetic force along the Z direction can be expressed as

$$F = {m}_{z} \cdot \frac{{dB}_{z}}{dz} \qquad ( 25 )$$

To calculate the magnetic interaction force between the permanent magnet and the electromagnetic coils and simulate the impact velocity and power, the magnetic moment of the permanent magnet should be clarified in advance. Here, a NdFeB magnet with an overall dimension (d) of 6.35 mm in diameter and 6.35 mm thickness (h) is used for the calibration. To calibrate the magnetic moment of the permanent magnet. Firstly, it is assumed the magnetization of this permanent magnet is Ma. In this case, the magnetic moment of the permanent magnet should be:

$${m}_{a} = V {M}_{a} \qquad ( 26 )$$

where V is the volume of the permanent magnet and

$$V = \frac{1}{4} π {d}^{2} h .$$

The permanent magnet is assumed as a dipole to simplify the calculation process. The magnetic field of the magnetic dipole depends on the magnetic moment and the direction of the dipole but drops off as the cube of the distance. The magnetic field generated by the dipole moment can be expressed as

$${B}_{a} = \frac{{μ}_{0}}{4 π} ( \frac{3 r ( {m}_{a} \cdot r )}{{‖ r ‖}^{5}} - \frac{{m}_{a}}{{‖ r ‖}^{3}} ) \qquad ( 27 )$$

Where μ₀ is the vacuum permeability and equals 4π×10⁻⁷N/A², r is the vector from dipole to the sampling point.

A constant factor k is introduced here to correct our assumption on the magnetization of the permanent magnet. Thus, the theoretical magnetic field at the sampling points can be reflected as

$${B}_{t} = k \frac{{μ}_{0}}{4 π} ( \frac{3 r ( {m}_{a} \cdot r )}{{‖ r ‖}^{5}} - \frac{{m}_{a}}{{‖ r ‖}^{3}} ) \qquad ( 28 )$$

To determine the value of the constant factor, the magnetic field of several points in the workspace is measured, as shown in FIG. 7b. The magnetic field changing trend is consistent with the dipole model; that is, the magnetic field decreases with the cube of the distance. The measured magnetic field is recorded as Be. A single-axis magnetic sensor is used to measure the magnetic field density, as shown in FIG. 7b, where the magnetic along the rotational axis is measured, and the assumed magnetic field and measured magnetic field can be replaced by Ba and Be, respectively. In this way, the constant factor can be expressed as

$$k = \frac{1}{n} {\sum }_{i = 1}^{n} \frac{‖ {B}_{e} ‖}{‖ {B}_{a} ‖} \qquad ( 29 )$$

Finally, the calibrated magnetic moment of the permanent magnet is

$${m}_{a} = k V {M}_{a} \qquad ( 30 )$$

Following the acceleration of the inner magnet, an impact force is generated upon its high velocity collision with the end cover. According to the law of conservation of momentum, the resulting force is modeled by

$${\int }_{0}^{t} {F}_{t} d t = {m}_{1} {v}_{1} - mv ,$$

where mi represents the mass of the magnet, m represents the mass of the whole robot, v₁ is the final velocity of the inner magnet before impact, v is the velocity of the robot after impact, and t is the impact time. Some parts of kinetic energy are cancelled by the robot frame because the robot frame is moving towards the opposite direction. After impacting, the microrobot continues to slide for a distance until it gradually stops, due to the friction between the microrobot and its environment. The sliding distance is determined by s=−mv²/2F_{f}, where F_{f} represents the friction force.

To maintain continuous locomotion, the inner magnet is repositioned to its initial position for the next cycle of acceleration and impacting against the end cover. Here, a square wave current with a bias is used as the input signal (see FIG. 8a). However, other types of alternating signal may also be used, but the amplitude in positive and negative directions are not the same to avoid locomotion cancellation. The repositioning movement is achieved by applying a lower current (In) in the opposite direction. The resulting field gradient generated by I, should be sufficient to drive the inner magnet back while ensuring that the final impact force remains below the static friction force to avoid unwanted backward locomotion. FIG. 8b shows the snapshots of the inner magnet and the robot during one cycle of actuation (with a load of 250 g). For the propelling process, the magnet can travel through the center channel within 14 ms with an input current of 0.5 A. The strong impact force creates a forward displacement (d) of the microrobot. In contrast, a lower current in the opposite direction is selected as the input signal to reposition the magnet (−0.05 A in this paper unless otherwise stated). The impact force is not large enough to overcome the static friction force, and no backward displacement was observed. As a result, the magnet oscillates within the center channel, and the robot can move in the desired direction (see FIG. 8c).

To study the kinematics and optimize the impact power, theoretical modeling is conducted to investigate the correlation between the permanent magnet's impact speed and the microrobot's design parameters. The inner magnet is a cylindrical NdFeB magnet (N52, K&J Ltd.) with a diameter of 6.35 mm and a length of 6.35 mm. Each end of the robot frame is equipped with an electromagnetic coil wound by 200 turns of copper wire (diameter: 0.12 mm) layer by layer. Disregarding the friction between the inner magnet and the container, the center channel's length and the electromagnetic coils' layout are optimized. The theoretical calculation results in FIG. 8d show a range of channel lengths from 20 mm to 35 mm with increments of 5 mm and coil holder lengths ranging from 3 mm to 8 mm with increments of 0.1 mm. The vertical axis represents the simulated impact speed of the magnet when the current is set to 1 A for the simulation.

The simulation results indicate that the optimal impact energy could be attained with a channel length of 35 mm and a coil holder length of 5.1 mm. These specific dimensions yield an impressive impact velocity of the magnet at 3.11 m/s. It is worth noting that the impact speed demonstrates an increased trend with the length of the channel. However, this rate of increase gradually diminishes once the length reaches 30 mm, with only a marginal 0.36% increase observed between 30 mm and 35 mm. Regarding the length of the coil holder, narrow yet thick electromagnetic coils yield a strong magnetic field in proximity to the coil but a weaker field in the near central region. Conversely, wide and flat coils enhance the magnetic density near the central area while reducing the density near the coil. According to the simulated result and to simplify the design, a coil width of 5 mm and a channel length of 30 mm are selected as the design of the MiaBot.

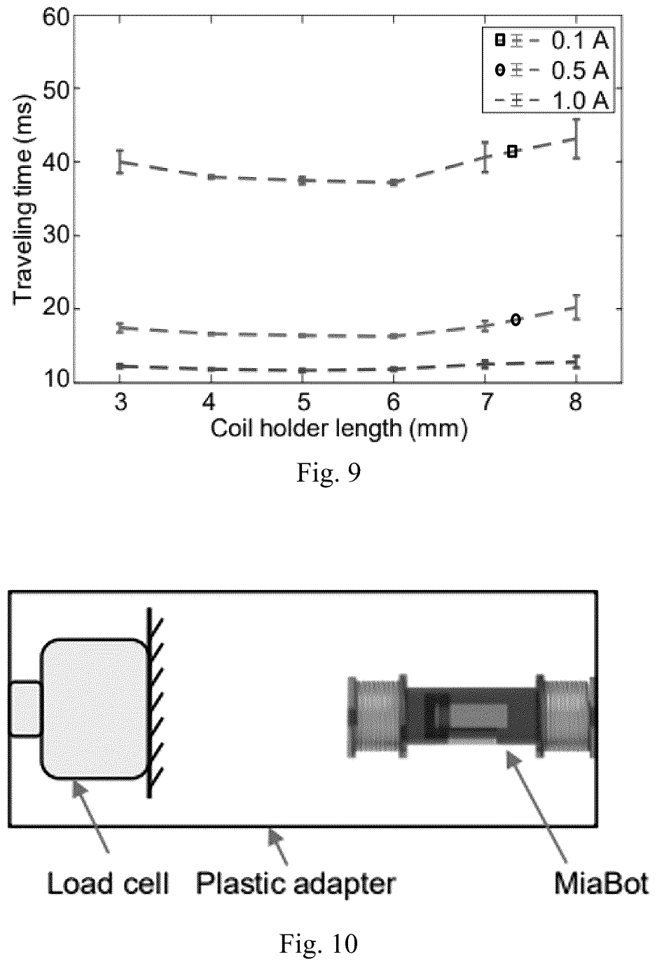

To validate the simulation results, the travel time of the inner magnet are experimentally measured with different coil holder lengths while varying the input currents from 0.1 A to 1.0 A. As depicted in FIG. 8e, the experimental results confirm that the robot with a holder length of 5 mm propels the permanent magnet faster than those with holder lengths of 3 mm and 8 mm under the same input current. This experimental observation agrees with the simulation results. The inner magnet swiftly traverses the center channel in less than 50 ms with an input current of 0.1 A. Furthermore, the time reduces to less than 15 ms as the current increases to 1 A. Additionally, only slight fluctuations is noted in traveling time when the coil length varied between 4 mm and 6 mm (see FIG. 9). The results in FIG. 9 show the magnet can slide from one side to the other side very quickly (<50 ms). The magnet can slide faster when the coil holder length is about 5 mm than when the coil holder length is about 3 mm or 8 mm. Hence, manual wiring of the magnetic coils also proves to be a viable method for fabricating the microrobot. Subsequently, the average traveling speed and the final velocity of the inner magnet are calculated before impacting under the input currents ranging from 0.1 A to 1 A (see FIG. 8f). The results demonstrate that the inner magnet can pass through the center channel at a fast speed. In detail, the traveling speed is increased with a higher input current. With 1.0 A current input, the average velocity is about 2.06 m/s during the acceleration process, which reaches 2.93 m/s before impacting the robot frame. Experimental results presented in FIG. 8f indicate that the robot takes more time to pass through the channel and impacts at a lower speed compared with the simulation results. This discrepancy can be attributed to the neglect of friction between the inner magnet and the skeleton in the simulation and the idealized assumption of the inner magnet being positioned precisely at the channel's centerline.

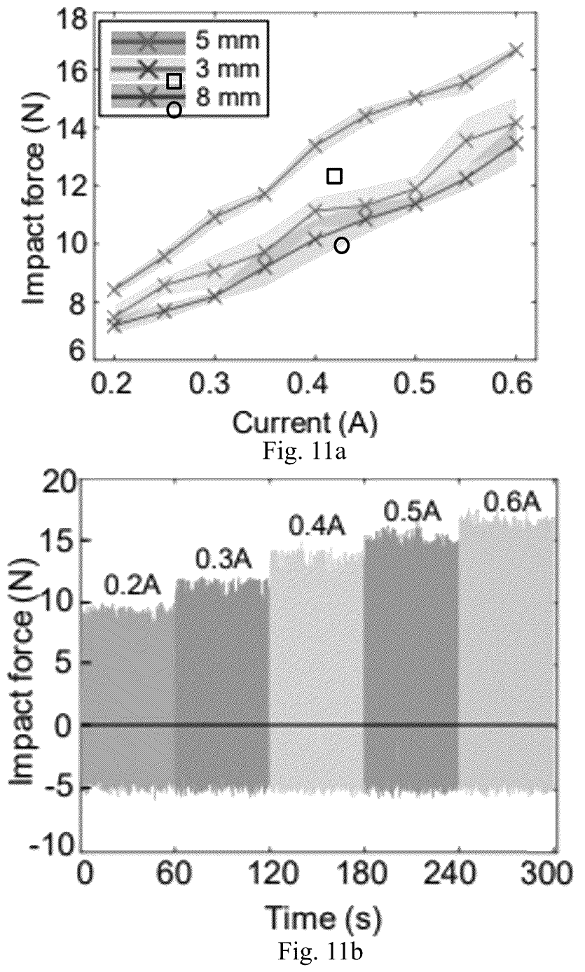

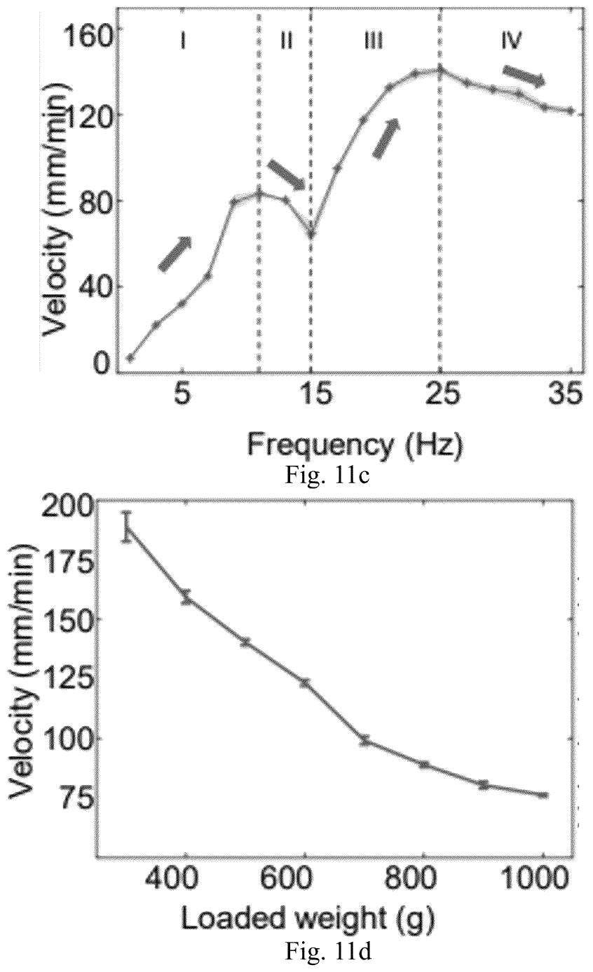

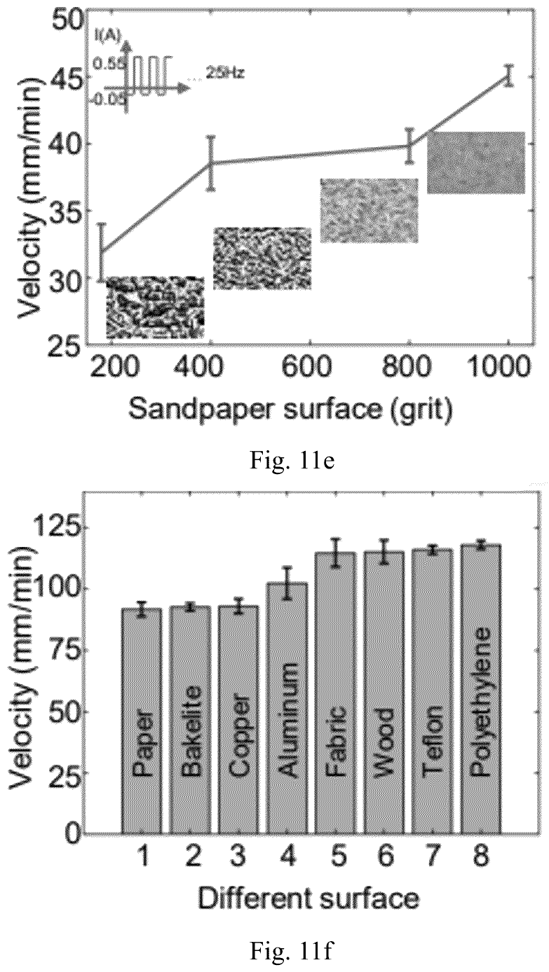

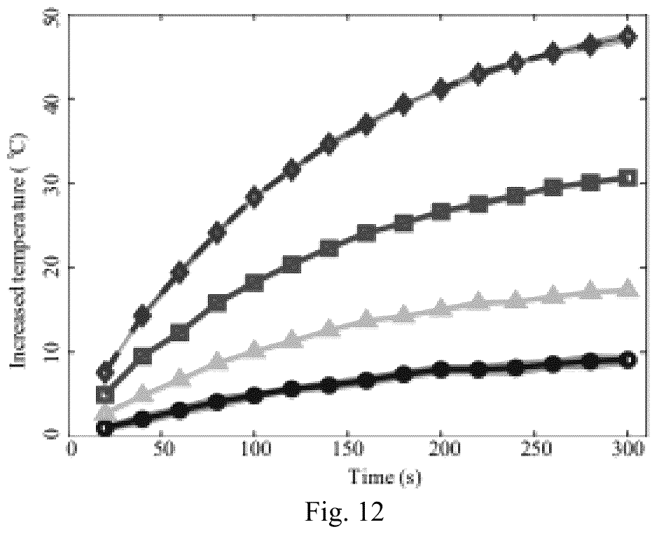

To accurately quantify the powerful impact force, a high-frequency force sensor was employed to measure the thrust force in one cycle. The schematic diagram of the measuring setup can be found in FIG. 10. A load cell and the MiaBot are attached on two ends of a plastic connector (which has the shape of a rectangular frame), respectively. The load sell is connected to a data acquisition system. The magnetic impact force of the MiaBot can be reflected as pressing and pulling forces on the load cell. The measurement was repeated ten times with input currents ranging from 0.2 A to 0.6 A with increments of 0.05 A. The resulting average impact forces and their corresponding standard deviations for robots with coil holder lengths of 3 mm, 5 mm, and 8 mm are illustrated in FIG. 11a. The experimental results indicate that the microrobot with a coil holder length of 5 mm exhibits the strongest impact among the different configurations. At an input current of 0.2 A, the average impact force measures 8.42 N, which increases to 16.67 N when the input current reaches 0.6 A. Although the impact force is slightly lower when coil holder lengths are 3 mm and 8 mm, it remains consistently above 13 N under an excitation current of 0.6 A. FIG. 11b showcases the repeatability of the impacting behavior of MiaBot, where the forward actuation current (Ip) is set between 0.2 A and 0.6 A, while the backward current (In) remains constant at 0.05 A. The actuation frequency is set at 2 Hz for one minute to evaluate the impact performance. The results show the impact force is stable with minimal fluctuations that may be attributed to measurement errors, given the extremely short duration of the impact process (at the millisecond level). The heat accumulation was also measured to confirm the safety of the robotic frame material under heat dissipation (shown in FIG. 12).

One thing that should be ensured is that the heat accumulation cannot break the robot, and the highest temperature point of the robot is recorded using a thermal imager. The increased temperature of the robot after the operation of 300 s is shown in FIG. 12. The temperature increases lower than 10° C. when the input current is 0.2 A, and it comes to 48° C. when the input current is 0.5 A. The temperature is safe for the skeleton material (PEEK, thermal denaturation temperature: 300° C.) used for the robot.

The impacting force of the MiaBot empowers the robot with a strong loading capability. Firstly, the locomotion performance of the robot with a load of 500 g (85.91 times its body weight) is investigated. The quantitative investigation was conducted by applying a square wave input with frequencies ranging from 1 Hz to 35 Hz, along with a bias current of 0.5 A.

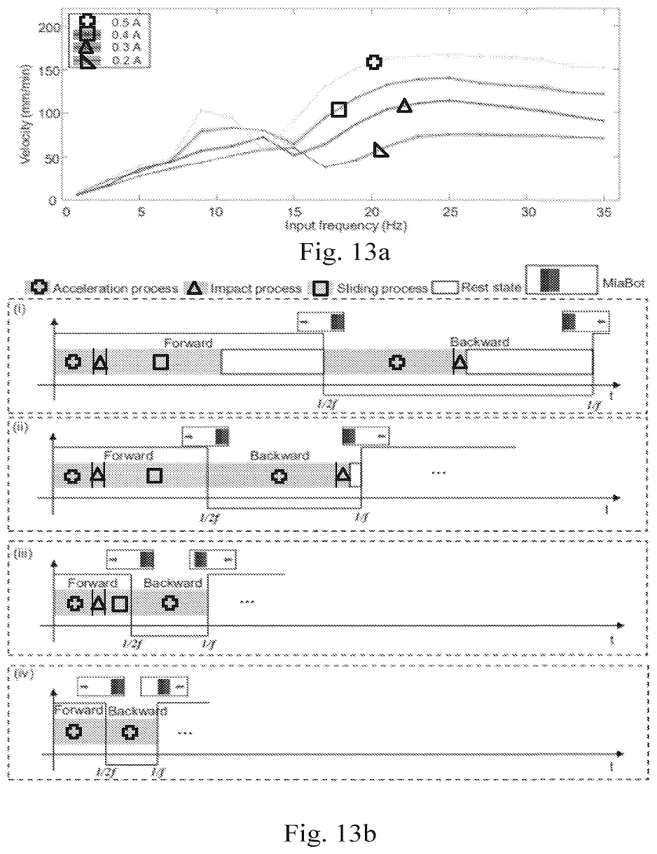

As shown in FIG. 11c, the optimal selection of input frequency is intricate and dependent on the magnitude of the input current. The velocity increases with the applied frequency during the initial stage (below 10 Hz) because more impacting cycles occur in a fixed time. As the frequency further increases, a decline in the velocity occurs due to the frequent backward impacting process, which plays a role in impeding the forward motion. In the third stage, the velocity rises again as the applied frequency increases because the inner magnet does not have enough time to impact the back cover, thus preventing the cancellation of the robot's forward motion. However, this upward trend is confined by an upper limit that can restrict the forward acceleration distance, resulting in reduced impact velocity and final force output. Detailed analysis and optimal selection of the input frequency can be found in FIGS. 13a-13b. Experiments are repeated by different bias currents ranging from 0.3 A to 0.6 A, as shown in FIG. 13a. The velocity versus frequency curves shows four stages, and the most favorable choices for these inputs converge around 25 Hz. The experimental result shows the recorded maximum speed is 92 mm/s under a 10 Hz square wave signal (positive 0.45 A, negative 0.05 A) input. The velocity is about 3.4 body length/s. Moreover, bi-directional control is important to complete point to point tasks, especially in tubular environment. The MiaBot can achieve bi-directional steering by simply reversing the positive current and negative current (i.e., positive 0.05 A, negative 0.45 A).

As shown in FIG. 13a, the velocity of the MiaBot is related to the input frequency. It can be divided into four stages when the input frequency is from 1 Hz to 35 Hz with an interval of 2 Hz. In the first stage, from 1-11 Hz, the velocity of the robot increases with the input frequency, which is then slightly decreased when the frequency is further increased to 15 Hz. In the third stage, the velocity is increased again and can obtain the highest speed when the input frequency is 25 Hz, while this trend is reversed when further increases the input frequency. A detailed analysis of these four stages is depicted in FIG. 13b.

FIG. 5a shows that one cycle of the actuation process contains three processes for forward actuation and one process for backward process. Forward actuation includes the acceleration of the permanent magnet, which impacts the robot's end cover of the shell and the MiaBot's sliding after impact. Because of the low impact force of the backward actuation process, impact and sliding may not result in any locomotion of the MiaBot. The acceleration process and impact process are simply considered for the backward actuation process. As shown in FIG. 13b, the acceleration process, impact process, and sliding processes are represented by blocks with different symbols, respectively, and the length of the blocks represents the time cost for the related process (only for reference but not exactly the real-time). The empty block (rest state) means no locomotion happens, but the current still exists. The insert MiaBot shows the relative position of the permanent magnet with the robot frame.

As for the acceleration process, the permanent magnet can keep accelerating until hitting the cover of the shell. The acceleration value at each sampling point along the center line of the channel can be written as

$${a}_{i} = \frac{{m}_{z}}{{ω}_{1}} \cdot \frac{d {B}_{z}^{i}}{{d}_{z}} \qquad ( 31 )$$

where w₁ is the weight of the permanent magnet, B_{p z} is the magnetic field at point P and in the z direction.

The time cost for the acceleration process is

$${t}_{a} = {\sum }_{i = 1}^{n} \frac{\sqrt{- \frac{2 Δ {B}_{z}^{i + 1} {m}_{z}}{{ω}_{1}}} - \sqrt{- \frac{2 Δ {B}_{z}^{i} {m}_{z}}{{ω}_{1}}}}{{a}_{i}} \qquad ( 32 )$$

where n is the number of the sampling point along the center line of the channel,

$$Δ {B}_{z}^{i + 1} {m}_{z} and Δ {B}_{z}^{i} {m}_{z}$$

are the magnetic potential energy at point i+1 and point i, respectively. The acceleration time-cost for the backward process is denoted as t b a here.

The impact process can be depicted by the kinetic energy theorem:

$${t}_{i} = \frac{ω {V}_{2} - {ω}_{1} {V}_{1}}{{F}_{i}} \qquad ( 33 )$$

where tᵢ is the impact time, Fᵢ is the impact force, w is the weight of the MiaBot and the carried weight, V₂ is the velocity of MiaBot after impact, and V₁ is the velocity of the permanent magnet before impact. The impact time-cost for the backward process is denoted as

$${t}_{i}^{b}$$

here.

After the impact, the MiaBot will slide on the ground with an initial velocity of V₂. The sliding process is uniformly decelerated under the effect of the friction between the MiaBot and the ground. The time cost for the sliding process is:

$${t}_{s} = \frac{ω {V}_{2}}{{F}_{f}} \qquad ( 34 )$$

where Ff is the friction force between the MiaBot and the ground.

In summary, the best choice for the selection of frequency to achieve a higher locomotion speed is.

$$f = \frac{1}{{t}_{a 1} + {t}_{i} + {t}_{s} + {t}_{a 2}} \qquad ( 35 )$$

where tₐ₁ is the time cost for the forward acceleration process of the magnet and tₐ₂ is the time cost for the repositioning process of the magnet.

Note that, the above input frequency for the four stages is the recommended value because the effects of friction, air resistance, and coil impedance on the robot's locomotive behavior are ignored. The more specific values of input frequency should be calibrated and evaluated according to the experiment results.

The locomotion performance with high loading capacity was subsequently assessed on a polymethyl methacrylate plate with the actuation frequency at the optimized frequency, i.e., 25 Hz (see FIG. 11d). The observed velocity is higher than 90 mm/s. The results reveal a decrease in moving speed with the increasing load, ranging from 300 g to 1000 g. With a load of 300 g, the microrobot achieves an average velocity of 188.73 mm/min. The speed decreases to 76.3 mm/min when the payload increases to 1000 g (171.82 times its body weight). To investigate the robot's locomotion capability on different surfaces, MiaBot carrying 250 g of cargo was tested on different types of surfaces. FIG. 11e demonstrates the locomotion speed of MiaBot on various sandpapers, with insets showing physical images (5× magnification) of four different roughness levels (i.e., 180 mesh, 400 mesh, 800 mesh, and 1000 mesh). The results indicate that MiaBot is capable of carrying a high payload to move on rough surfaces. And faster locomotion speed is observed on smoother surfaces. Furthermore, to assess the locomotion reliability, the microrobot with a 500 g payload is tested on various surfaces such as metal, plastic, fabric, and wood (see FIG. 11f). The results prove that the microrobot is capable of carrying a heavy payload to move at a speed constantly above 75 mm/min on a variety of surfaces. As indicated by the small error bar in FIG. 11f, the locomotion is stable across most substrates, particularly on smooth surfaces that are not adhesive, such as fabric, wood, teflon, and polyethylene.

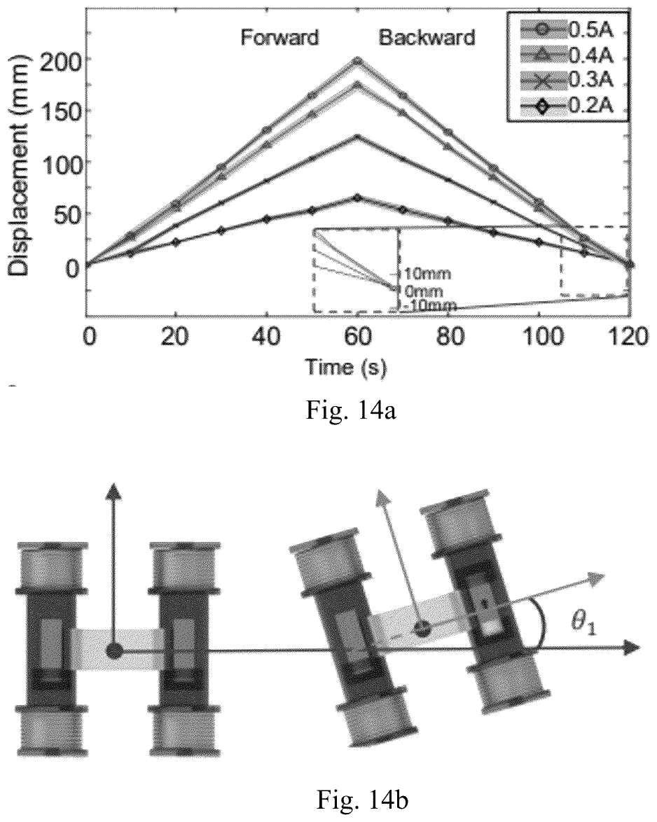

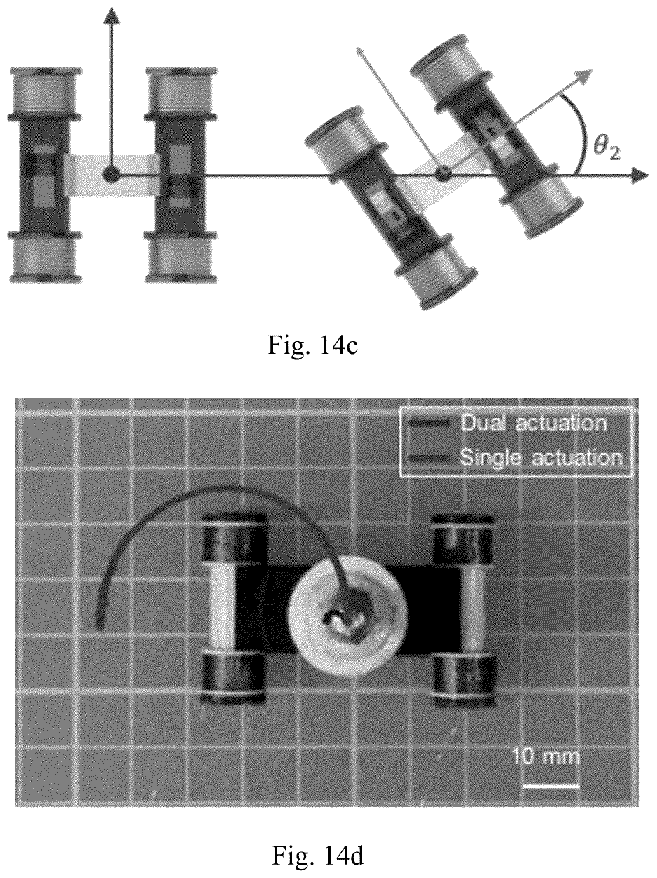

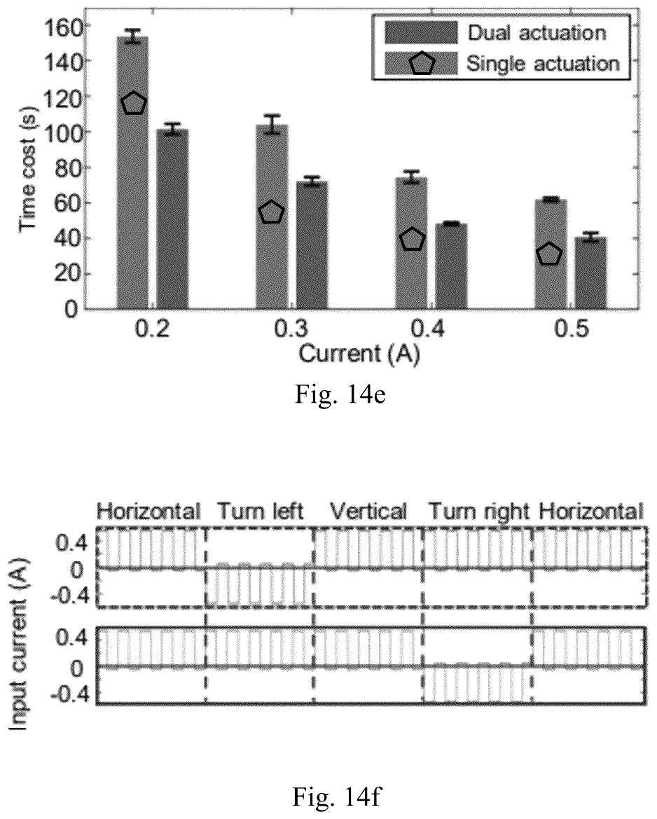

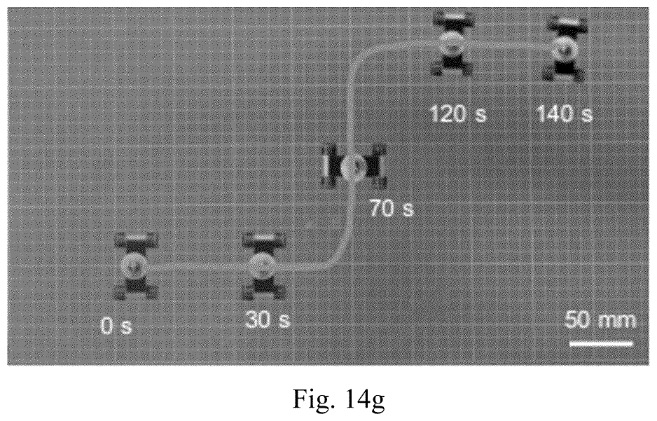

Steerability is critical for insects to inhabit and navigate through complex and unstructured terrains. Replicating this steerability in small-scale robots is highly desirable for accomplishing intricate tasks. Most existing small robots rely on periodical body contraction and stretching to move forward [34]-[37]. The movement of these robots relies on the asymmetrical friction force between the robots and the ground; therefore, they have limited directional steering capability to change the movement direction or move backward. However, bi-directional control is a highly desirable feature for small robots to complete point-to-point transportation tasks or navigate in confined environments (e.g., biological tubular organs). In a preferred embodiments of the invention, the bi-directional control of the microrobot can be achieved by simply reversing the biased direction of the input current. For example, the microrobot can move to a new position, and then move back to the initial position after one minute of forward and backward locomotion. The experiments were conducted by different bias currents and repeated five times. FIG. 14a depicts the real-time displacement of the robot, showing the Miabot can return to the initial position to complete bidirectional control. Full directional maneuverability is a preferred function for microrobots to accomplish complex tasks, such as following a trajectory and navigating unstructured environments. In the MiaBot, the orientation adjustment is achieved by assembling two individual actuation units in parallel and controlling them individually.

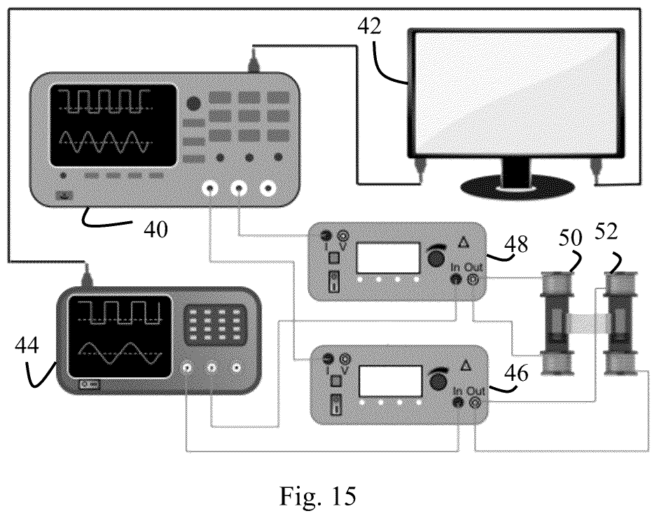

The control system of the parallel units is shown in FIG. 15. Firstly, a host computer 42 is used to generate signal commands to control a signal generator 44. The commands should conclude what kind of wave to generate and other detailed control parameters. For example, a square wave may be used at all time to control the MiaBot, and the input frequency, the bias current, and the duty cycle of the input signals should be determined. The signal generator 42 used herein is a multi-channel one, which can generate up to three signals independently. The output signal from the signal generator 44 is then increased to the desired amplitude via amplifiers. Because the MiaBot is composed of two independent actuators 50, 52 for some tasks like omnidirectional steering, two amplifiers 46, 48 are prepared here to amplify the signals from two separate channels. The signals from two channels can be selectively and independently controlled and switched; thus, omnidirectional steering can be achieved. To verify the input signal and determine the input command, an oscilloscope 40 is utilized here for real-time monitoring of the signal performance. If there is any drift between the output signal from the amplifiers 46, 48 and the wanted one, one can change the control instructions of the signal generator in time to ensure the MiaBot can operate in the manner as desired. The real-time state of the MiaBot is detected by a CMOS camera. For example, the real-time position and orientation can be determined via the morphological processing of images collected by the CMOS camera. The position and orientation information can then be used as feedback to adjust the control strategies and control commands.

In the exemplary experiment setup, a three-channel wave generator is used to generate the desired signal (FY8300, FeelElec Inc., China). The three channels can provide any waveforms according to the generating commands and can be independently controlled. The controllable parameters include frequency, duty cycle, bias voltage, etc. The generated wave is then amplified to a suitable voltage via an amplifier with a limited voltage of 50 V and a current of 4 A (PS-LG504, Hu Nan Pai Sheng Elegance Technology CO., LTD). On the one hand, the output voltage is connected to the MiaBot to drive the robot. The real-time current is also monitored by an oscilloscope (TBS 1102C, Tektronix) to determine whether the waveform meets the driving requirements. The acceleration time of the permanent magnet from one end of the center channel to the other is reflected by a high-speed camera (pco. dimax S4, PCO.). The high-speed camera can record videos at 4500 fps with 1008×1008 pixels. A piezoelectric force sensor is applied to measure the impact force of the permanent magnet (1051V1, DYTRAN, USA). The sensor can measure the force up to 10 Lb with a frequency of 50 kHz. The measured signals are then stored in a data acquisition system (IOLITEi-1×ACC, Althen sensors & controls). The real-time state of the MiaBot is captured by a CMOS camera (JW-02, tiantianquan). The figures are then transferred to the host computer and processed by MATLAB (MathWorks. Inc) for real-time position and orientation detection. The temperature of the electromagnet is measured by an infrared thermal imager (UTi260B, UNI-T). The magnetic field density is detected by a Gaussmeter (HGM09s from MAGSYS) with a measuring range from 1 mT to 4.5 T and a resolution of 1 μT. The silicon oil used for evaluating the experimental adaptability of the MiaBot is PX-200 (DOW CORNING). The granular medium used here is hollow ceramic microbeads with a diameter of 20-40 mesh (Henan Hengyuan New Material Co., Ltd). The natural sand is from the Tengger Desert (Gan Su province).

To investigate the full directional maneuverability of the microrobot, two turning strategies are compared in FIGS. 14b-14c: the conventional one-side switched-off method and the dual actuation mode where two individuals operate simultaneously but in opposite directions. The conventional one-side actuation strategy (see FIG. 14b) produces a large drifting mass center (solid dot represented), while the mass center remains stationary under the dual actuation mode (see FIG. 14c), indicating the robot can work in a limited space with a small turning radius. Furthermore, for a specific time interval, the turning angle in the synergy actuation mode (θ₂) is larger than that in the single actuation mode (θ₁), showing a higher turning efficiency using the dual actuation strategy.

To quantitatively evaluate the maneuverability, the microrobot was tested to turn 180° on a polyvinyl chloride plate with 70 grams (see FIG. 14d) and 500 grams of payload. The experimental results in FIG. 14d confirm that the single actuation mode exhibits a significant drift (361.12 mm) in the body center of the robot. In comparison, only a slight drift (9.44 mm) occurs under the synergy actuation mode. The time cost for turning 90° with a load of 500 grams under different actuation currents is depicted in FIG. 14e. The results indicate that dual actuation takes less time than the conventional single-actuation method to change the directions (about 1.5 times faster with synergy actuation). The highly efficient steerability enabled by full directional control is particularly useful for heavy cargo delivery.

To evaluate the trajectory-following capability, tests are conducted by controlling the microrobot to follow a ‘Z’-shaped trajectory; the trajectory includes horizontal, vertical, left-turn, and right-turn tracks. The input current for the left and right actuators is illustrated in FIG. 14f. Initially, both actuators are operated with positive bias currents to move horizontally. As the robot approaches the left turn corner, the bias current of the left actuator is switched to a negative direction. In the subsequent vertical locomotion stage, both actuators' bias currents return to positive. During the right-turning process, the bias current of the right actuator is switched to the negative direction. Finally, the robot completes another horizontal locomotion stage using the same input current as the first stage. The process of the robot moving following the ‘Z’-trajectory is shown in FIG. 14g.

In this section, a series of experiments is presented to demonstrate the MiaBot's superior locomotion capability on various terrains due to its substantial outputting power. The demonstrated challenging tasks include transportation of super heavy cargoes, locomotion in a highly viscous environment, operation in granular mediums, and drilling out through natural sand from a depth exceeding 100 mm.

To optimize the performance of MiaBot in a liquid environment, slanted fins pointing backward were integrated into the microrobot to increase the drag force and the locomotion efficiency. In contrast, a smooth surface was designed on MiaBot to minimize friction when traversing within granular media. Additionally, all the tested microrobots were equipped with conical heads to reduce resistance drag force between the robot and the surrounding media.

In the task of transporting super heavy cargoes, the MiaBot is demonstrated to be capable of carrying an 1800 g (309.28 times the robot's body weight) payload on a wooden surface. To the best of the inventors' knowledge, no miniature robot has reported such a competitive load-carrying capability before. Moreover, the MiaBot was also tested in a tank containing high-viscosity silicone oil (1000 cSt). Despite the intermittent backward tendencies during the oscillating impact process, the presence of slanted fins effectively counteracts any backward movement owing to their greater resistance in the backward direction. The findings suggest that the MiaBot holds the potential for applications in viscous environments (e.g., in crude oil pipelines). The MiaBot was also tested to traverse within a granular medium such as ceramic particles (diameter: 0.5 mm-1.0 mm). A red flag was attached to the robot for demonstration purposes. Eventually, the robot managed to emerge from the medium owing to the asymmetric resistance between its bottom and top surrounding environment [16]. To simulate a natural environment, the robot was then tested underground amidst soil, sand, ceramic particles, and plants. The results demonstrate the capability to navigate through various complex environments. Moreover, the MiaBot's ability to drill out through natural sand is assessed, reaching depths exceeding 100 mm from the surface is assessed. As far as is known to the inventors, this represents the first instance where a microrobot can be operated in a sand environment at such depths.

The MiaBot has also demonstrated promising potential in various potential biomedical scenarios, including biopsy and drug delivery, owing to its small scale and powerful force output. In the biopsy experiments, a sharp needle is attached to the inner magnet to extract samples from pig tissues. The MiaBot is fixed at the end of a catheter as the functional tip. When the catheter is navigated to the lesion area, the sharp needle within the MiaBot can be extended and retracted from the center channel as the inner magnet oscillates. The scale of MiaBot is comparable to that of commercial endoscopes, enabling it to tackle challenging tasks within tubular environments such as the gastrointestinal tract. The pig tissues with different moduli (flesh and adipose) are firmly attached within the tubular environments to simulate tumors of different hardness. Experimental results demonstrate the successful penetration of both flesh and adipose tissues by the sharp needle-assisted MiaBot. This new design of the microrobot opens possibilities for biopsy and examination of lesion tissues in patients with tubular diseases (e.g., duodenal and colorectal cancers).

In addition, in-situ drug delivery is of significant importance in treating conditions such as hemostasis and inflammation amelioration. Conventional medical devices for drug delivery often suffer from complex structures and limited drug loading capacity. In contrast, the MiaBot is constructed with simple structures and has a space of 0.73 mL to store the medications. In detail, the middle channel of MiaBot serves as a drug housing space. Similarly, the MiaBot is attached to the end of a catheter, when the MiaBot reaches the targeted lesion area, the inner magnet can be activated to operate within the center channel for injecting drugs to the desired location.

In summary, one can see from the exemplary embodiments described above that inspired by the innovative locomotion systems observed in crawling hawkmoth caterpillars (Manduca sexta), a new robot where the inner magnet can oscillate within the center channel of the robot body frame. This magnetic microrobot prototype is characterized by its lightweight (5.82 g), small scale (4|12 mm×30 mm), and cost-effectiveness. The advantage of the new design lies in the embedded electromagnetic coils and a magnet, which enable inner actuation that does not require an external magnetic field. This new actuation mechanism offers three significant advantages. Firstly, the robot is not confined to a limited workspace, as the inner actuation mechanism can function regardless of the microrobot's location. Secondly, compared to bulky magnetic actuation systems relying on external magnetic sources, this new design generates stronger interaction forces with less power consumption, thanks to the close distance between the coils and the inner magnet. Thirdly, the straightforward energy conversion mechanism of the proposed MiaBot allows it a direct, powerful force output at a smaller scale than conventional electromagnetic motors that output torque and rely on complicated gears and bear systems.

To achieve maximum impact force and efficiency, the magnetic interaction force and impact energy are theoretically modeled, and the design of the robot frame is optimized. These design considerations enable the microrobot to deliver large force output while maintaining the robot at a small scale. The distinguished loading performance demonstrates the capability to overcome the high resistance on the ground. A comprehensive comparison of the load-carrying capacity of the MiaBot is made with various state-of-the-art small robots that utilize different actuation mechanisms, including shape memory alloy, dielectric elastomer actuators, piezoelectric motors, magnetic polymers, thermally sensitive materials, and conventional electromagnetic motors (see FIG. 3a and Table 3). The figure demonstrates that the majority of existing small robots are only capable of transporting cargo weighing less than 50 times their own weight. In contrast, the MiaBot is capable of handling payloads weighing up to 1800 g, equivalent to 309.28 times its own weight.

TABLE 3
Comparison of time cost for turning 90° under
two actuation modes with different current inputs.

| Input | Time cost for turning 90° under two actuation modes(s) | |
|---|---|---|
| current (A) | Single actuation | Dual actuation |
| 0.2 | 768 | 507 |
| 0.3 | 520 | 360 |
| 0.4 | 372 | 241 |
| 0.5 | 309 | 203 |

Additionally, a comparison is conducted between the loading capabilities of the proposed robot and various creatures, such as ants, beetles, eagles, chimpanzees, human beings, and elephants (see FIG. 3b, and Table 1 of FIG. 4a). The results highlight the MiaBot's superior loading capability compared to most mammals, which typically carry cargo less than ten times their own weight. The proposed new microrobot outperforms most of the ant species. While beetles are renowned for their impressive load-bearing capacity, the MiaBot demonstrates a comparable capability. These findings underscore the exceptional load-carrying potential of the MiaBot, solidifying its position as a leading contender in microrobotics.

The MiaBot also demonstrates remarkable locomotion capabilities, particularly in challenging environments characterized by high resistance, such as silicon oil with a viscosity of 1000 cSt, granular media, and deep natural sand. These experiments highlight the potential of MiaBot for various applications in industrial and agricultural domains. For instance, MiaBot can be equipped with a vision inspection unit to detect defects in oil pipelines. It is worth noting that the silicone oil used in this study has higher viscosity compared to other commonly used liquids such as water, castor oil (250-800 cSt), and compressor oil (50-500 cSt), demonstrating its potential to be deployed in various scenarios. This experiment proves that the MiaBot can be used to check the status of oil pipelines such as whether there is a leak, etc. Furthermore, pH and moisture sensors can be integrated into MiaBot to monitor the physicochemical properties of soil. Another notable advantage of MiaBot is its steerability and controllability, which distinguishes it from other small robots. The bi-directional control capability can be achieved by simply reversing the direction of the bias current. Moreover, full directional control can be obtained with a higher turning efficiency and a smaller turning radius compared to conventional methodologies that rely on one-side switch-off-based strategies (see FIGS. 14a-14g).

Potential applications of MiaBot have been explored in medical scenarios, specifically in biopsy procedures and drug delivery. Equipping MiaBot with a sharp needle on the piston-like magnet demonstrates effective penetration capabilities in biological samples. Moreover, the functionality of drug release is demonstrated by utilizing the central channel of the robot frame to contain liquid medications, suggesting its potential for controllable drug delivery. These experiments exemplify MiaBot as a highly capable and controllable robotic system with vast potential.

In the next section, the MiaBot is compared with conventional electromagnetic motors-based robot, the miniature robot created by functional materials and the magnetic robot actuated by external magnetic sources. The results show the proposed miniature robot exhibits excellent performance in many aspects, such as easy fabrication, cost friendly, fast responsibility, and reliability control etc., The details are shown in below:
Simple structure and lightweight. Compared with conventional electromagnetic motors that rely on complex transmission components, the MiaBot has a simple structure without relying on gears and bears.
Straightforward force output. Most conventional electromagnetic motors output energy in the form of magnetic toque. The MiaBot can output the thrust force directly. The straightforward conversion of electrical energy into output force allows the robot to output powerful force more efficiently.
Fast responsibility. Compared with the miniature robot created by functional materials, such as thermal sensitive polymer, dielectric elastomer actuators, shape memory alloy-based actuators, and liquid crystal elastomers. Some of them require long time to heating up and cooling down. Moreover, the MiaBot can be operated at a high frequency than most soft owing to the viscoelastic properties of soft materials.
High controllability. Most existing miniature robots rely on periodic contraction and stretching their body to locomote. The net displacement after a cycle of contraction and stretching is realized by the asymmetrical friction between the robot's feet and the ground. However, the asymmetrical design makes the robot difficult to achieve bi-directional control. The MiaBot is actuated by a square wave with bias current. Bi-directional control can be achieved simply reverse the direction of bias current.
Theoretically unlimited workspace. Many existing magnetic robots rely on external magnetic sources to provide actuation field. The typical external magnetic sources setup includes fixed electromagnetic coils array, moveable coils and permanent magnet installed on the robot arm, etc. Compared with magnetic robots that rely on external actuation magnetic sources, the MiaBot integrates with both actuation coils and the permanent magnet, which means the proposed robot can be operated anywhere without limitation in workspace.
Strong outputting force. Compared with external magnetic sources-based actuation system, the MiaBot provides a stronger outputting force when the system inputs the same power. The reason is the magnetic force decreases as

$$\frac{1}{{r}^{4}}$$

(r is the characteristic distance between the object and the magnetic sources) and the distance between the embedded coils and permanent magnet in the MiaBot system is much shorter than external actuation systems.
Cost friendly. The MiaBot has a simple structure. The components include a permanent magnet, a plastic frame, two plastic covers and some coils. All the materials are cheap, and the fabrication process is simple without relying on expensive equipment. The more expensive and high accuracy component such as gears and bears and are not required in the MiaBot.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

1. A microrobot, comprising:
a) a frame having a central channel;
b) a permanent magnet received in and adapted to move relative to the central channel;
c) a first electromagnetic coil configured near a first end of the central channel; and
d) a second electromagnetic coil configured near a second end of the central channel;
wherein the permanent magnet is adapted to locomote within the channel upon energization of the first electromagnetic coil and/or the second electromagnetic coil, which provides an interaction force and an impact force between the permanent magnet and the frame that are adapted to drive the microrobot to move on a surface.

2. The microrobot of claim 1, wherein the central channel has a cylindrical shape; the first and second electromagnetic coils wound respectively around first and second ends of the frame.

3. The microrobot of claim 2, further comprises a coil holder for the first electromagnetic coil or the second electromagnetic coil which is evenly distributed on the coil holder; the coil holder configured at an exterior surface of the frame at a respective end of the frame.

4. The microrobot of claim 3, wherein the coil holder comprises grooves formed on an exterior circumferential surface of the frame.

5. The microrobot of claim 3, wherein the coil holder has a length of 5 mm.

6. The microrobot of claim 1, wherein the first and second electromagnetic coils have different winding directions.

7. The microrobot of claim 6, wherein the first and second electromagnetic coils are electrically connected in series.

8. The microrobot of claim 1, further comprises an end cover at each end of the central channel; the end covers adapted to be impacted by the permanent magnet to provide the impact force.

9. The microrobot of claim 6, wherein the first electromagnetic coil is adapted to generate an attractive force to the permanent magnet while the second electromagnetic coil is adapted to generate a repelling force, and vice versa.

10. A method of driving a microrobot to move on a surface, comprising steps of:
a) applying a first magnetic force, along a first direction, to a permanent magnet received in a central channel of a frame such that the permanent magnet moves toward and impacts a first end of the frame; the frame moving as a result of the impact;
b) ceasing the first magnetic force;
c) applying a second magnetic force, along a second direction opposite to the first direction, to the permanent magnet such that the permanent magnet moves away from the first end of the frame and impacts a second end of the frame that is opposite to the first end; and
d) ceasing the second magnetic force.

11. The method of claim 10, wherein each of the first and second magnetic forces is provided by a first electromagnetic coil configured near a first end of the central channel; and/or a second electromagnetic coil configured near a second end of the central channel.

12. The method of claim 10, wherein Steps a) to d) are repeated so that the microrobot continues to move on the surface.

13. The method of claim 10, wherein the first and second electromagnetic coils have different winding directions.

14. The method of claim 13, wherein the first and second electromagnetic coils are electrically connected in series.

15. The method of claim 14, wherein Steps a) and c) are executed by applying respectively a first current to the first and second electromagnetic coils, and a second current in an opposite direction than the first current to the first and second electromagnetic coils.

16. The method of claim 15, wherein the second current is smaller than the first current in magnitude.

17. The method of claim 14, wherein Steps a)-d) are executed by applying a square wave current to the first and second electromagnetic coils.

18. The method of claim 10, wherein the second magnetic force is below a static friction force of the microrobot on the surface.
